(19) United States
(12) Patent Application Publication
(10) Pub. No.: US 2010/0208413 A1
(43) Pub. Date: Aug. 19, 2010

(54) INTRINSICALLY CONDUCTIVE POLYMERS

(75) Inventors: Patrick J. Kinlen, Fenton, MO (US); June-Ho Jung, Springfield, MO (US); Sriram Viswanathan, Springfield, MO (US); Joseph Mbugua, Springfield, MO (US); Young-Gi Kim, Springfield, MO (US)

Correspondence Address: Nelson Mullins Riley & Scarborough LLP;IP Department, 100 North Tryon Street, 42nd Floor, Charlotte, NC, 28202-4000, US

(73) Assignee: LUMIMOVE, INC., D/B/A CROSSLINK, St. Louis, MO (US)

(21) Appl. No.: 12/630,924

(22) Filed: Dec. 4, 2009

Related U.S. Application Data
(60) Provisional application No. 61/200,830, filed on Dec. 4, 2008.
(60) Provisional application No. 61/200,829, filed on Dec. 4, 2008.

(51) Int. Cl. H01G 9/058; B05D 5/12; B08B 5/00

(52) U.S. Cl. 361/502; 427/58; 134/31

(57) ABSTRACT

A method of doping an intrinsically conductive polymer film is provided. The method includes contacting the film with a first acid dopant to form a primary doped intrinsically conductive polymer film; cleaning the primary doped intrinsically conductive polymer film by contacting the primary doped intrinsically conductive polymer film with a vapor; dipping the vapor-cleaned primary doped intrinsically conductive polymer film into a solution including at least a second acid dopant and an organic solvent to form a secondary doped intrinsically conductive polymer film; and annealing the secondary doped intrinsically conductive polymer film to produce a tertiary doped intrinsically conductive polymer film.

The present application claims priority to U.S. Provisional Patent Application Ser. Nos. 61/200,830 and 61/200,829, each filed Dec. 4, 2008, and each incorporated herein by reference in its entirety.

This invention was made with Government support under Contract Award W15QKN-07-C-0121, awarded by the Army Armaments Research, Development, and Engineering Center (ARDEC), Picatinny, N.J. The Government has certain rights in the invention.

### BACKGROUND OF THE INVENTION

The present invention relates to intrinsically conductive polymers (ICPs) and methods of making and doping ICPs.

### SUMMARY OF THE INVENTION

In one aspect, the present invention is directed to a supercapacitor. The supercapacitor includes a first substrate comprising a first and second surface; a first electrode comprising an intrinsically conductive polymer having a conductivity of at least about 800 S/cm and having a first and second side, wherein the first side is adjacent the second surface of the first substrate; an electrolyte adjacent the second side of the first electrode; a second electrode comprising an intrinsically conductive polymer having a conductivity of at least about 800 S/cm and having a first side and a second side, wherein the first side is adjacent the second side of the first electrode and separated from the first electrode by the electrolyte; and a second substrate having a first surface and a second surface, wherein the first surface is adjacent the second side of the second electrode.

In another aspect, the present invention is directed to a method of doping an intrinsically conductive polymer film. The method includes contacting the film with a first acid dopant to form a primary doped intrinsically conductive polymer film; cleaning the primary doped intrinsically conductive polymer film by contacting the primary doped intrinsically conductive polymer film with a vapor; dipping the vapor-cleaned primary doped intrinsically conductive polymer film into a solution including at least a second acid dopant and an organic solvent to form a secondary doped intrinsically conductive polymer film; and annealing the secondary doped intrinsically conductive polymer film to produce a tertiary doped intrinsically conductive polymer film.

In yet another aspect, the invention is directed to a doped intrinsically conductive polymer film having a conductivity of at least about 800 S/cm.

These and other aspects of the invention will be understood and become apparent upon review of the specification by those having ordinary skill in the art.

### BRIEF DESCRIPTION OF THE DRAWINGS

FIG. 1 is a schematic of an exemplary Type I supercapacitor in accordance with the present invention.

FIG. 2 depicts the UV-Vis-NIR spectra of PAC™ 1003 films before heat treatment (ending at about 0.1) and after 150° C., 30 min heat treatment (ending at about 0.5).

FIG. 3 depicts the UV-Vis-NIR spectra of PAC™ 1007 films before heat treatment (ending at about 0.5) and after 150° C., 30 min heat treatment (ending at about 0.7).

FIG. 4 depicts the UV-Vis-NIR spectra of PTSA doped PAC™ 1003 films (top line) vs. pristine PAC™ 1003 films (bottom line) after heat treatment at 150° C. for 30 min.

FIG. 5 depicts UV-Vis-NIR spectra of PTSA doped PAC™ 1007 films vs. pristine PAC™ 1007 films after heat treatment at 150° C. for 30 min.

FIG. 6 depicts the UV-Vis-NIR spectra of PTSA-TSAm doped PAC™ 1003 films vs. pristine PAC™ 1003 films after heat treatment at 150° C. for 30 min.

FIG. 7 depicts the UV-Vis-NIR spectra of PTSA-TSAm doped PAC™ 1007 films vs. pristine PAC™ 1007 films after heat treatment at 150° C. for 30 min.

FIG. 8 depicts the UV-Vis-NIR spectra of PAC™ 1003 films vapor-cleaned with Thymol followed by film dip-doping in PTSA-TSAm solution.

FIG. 9 depicts the UV-Vis-NIR spectra of PAC™ 1003 films vapor-cleaned with Thymol, Carvacrol, IPP or DIPP followed by film dip-doping in PTSA solution.

FIG. 10 depicts the plot of four-probe DC electrical conductivity measured at room temperature (RT) of mechanically annealed PANI (PAC™ 1007) samples carried out on 150 μm Teflon substrate by stretching (at unknown stretch rate) to 140% and holding at 65° C. (using IR lamp) for 5 min followed by cooling to RT and release of stress.

FIG. 11 depicts the plot of four-probe DC electrical conductivity measured at RT of mechanical annealed PANI (PAC™ 1003) samples carried out on 150 μm PTFE substrate by stretching (at unknown stretch rate) to 140% and holding at 65° C. (using IR lamp) for 5 min followed by cooling to RT and release of stress. The sample films were prepared by spin-coating PAC™ 1003 films (1500 μL@1000 rpm for 30 s).

FIG. 12 depicts the charge-discharge cycling results of coin cells utilizing PAC™ 1003 films as electrode material and EMI-IM ionic liquid as the electrolyte (a) Pristine PAC™ 1003 and (b) 250 S/cm secondary-doped PAC™ 1003.

FIG. 13 depicts the potential window of coin cells in a chronopotentiometric charge-discharge cycling conducted up to 10,000 cycles utilizing (a) 250 S/cm secondary-doped PAC™ 1003 film (1^{st} 10,000 cycles) (b) 250 S/cm secondary-doped PAC™ 1003 (2^{nd} 10,000 cycles) (c) 250 S/cm secondary-doped PAC™ 1003 (3^{rd} 10,000 cycles) as the electrode and EMI-IM as the electrolyte.

FIG. 14 depicts the cyclic Voltammogram (CV) of coin cells utilizing 250 S/cm secondary-doped PAC™ 1003 electrodes and EMI-IM as the electrolyte.

FIG. 15 depicts the plot of electrical conductivity of PANI vs. device performance of coin cells utilizing high-conductive metallic PANI films as electrode material in EMI-IM Ionic Liquid electrolyte.

FIG. 16 depicts cyclic Voltammetric Scans performed on metallic PANI electrodes in EMI-IM ionic liquid electrolyte (in a three-electrode configuration with SCE reference and platinum counter electrode).

FIG. 17 depicts potential profiles of coin cells containing metallic PANI films (top and middle) and PISA-TSAm doped PANI films (bottom) as electrodes and EMI-IM as electrolyte (top) the 1^{st} 10,000 cycles and (middle and bottom) 3^{rd} 10000 cycles of charge-discharge testing along with a typical pattern of the chronopotentiometric profile of Gamry potentiostat. Current Cycling: ±1 mA (top and middle) & ±3 mA (bottom).

FIG. 18 depicts potential profiles of coin cells utilizing electrodes with a metallic PANI film containing Au interfacial layer performed in EMI-IM electrolyte.

FIG. 19 depicts coin cell device performance, including the effect of the presence of an interfacial layer sandwiched between metallic PANI and a SS disk on coin cell device performance characteristics such as a) energy and power densities as shown in the graph, and b) specific capacitance as shown in the CV scan plot.

FIG. 20 depicts the cycling stability experiment conducted up to 30,000 cycles using Chronopotentiometry to study the effect of the presence of interfacial layer in metallic PANI electrodes.

FIG. 21 depicts the charge-discharge cycling effect of the amount of mass of metallic PANI film coated on SS disk on coin cell device performance.

FIG. 22 depicts a plot showing the effect of introducing Li-IM as the second ionic liquid electrolytic component in EMI-IM electrolyte on device performance for coin cells utilizing electrodes with a metallic PANI-containing Au interfacial layer.

FIG. 23 is a schematic representation of bulk pellet accessibility by electrolyte.

FIG. 24 depicts the charge-discharge characteristics of PANI/DBSA/C-Fiber Coin cells, 1 mA, 1.0V (EMI-IM).

FIG. 25 graphically depicts the effects of hold time on charged and discharged Energy.

FIG. 26 depicts the charge discharge cycles of PANI/DBSA/c-fiber coin cells (EMI-IM) with 0 s hold time. High IR drop is shown by the arrow.

FIG. 27 depicts the charge-discharge cycle of a PAC™ 1003 pellet coin cell at 0.01 mA, 1.0V.

FIG. 28 shows increasing the carbon content increases the Energy.

FIG. 29 depicts charge discharge cycles of PAC™ 1003 with Carbon formulation.

FIG. 30 depicts discharged energy of activated carbon/carbon black/colloidal graphite solution in an IPO ratio of 30%/2%/68% w/w and an activated carbon control coin cell at 10 mA.

FIG. 31 depicts discharged energy of activated carbon and PAC™ 1003 formulations. As the voltage increases, the activated carbon had a slow but steady increase in power.

FIG. 32 depicts PAC™ 1003/activated carbon/carbon black in the ratio 45%/50%/5% w/w and activated carbon/carbon black/colloidal graphite solution in the ratio 30%/2%/68% w/w.

FIG. 33 depicts PAC™ 1003/carbon formulation and carbon control coin cell efficiencies at different charging and discharging conditions.

FIG. 34 depicts charge-discharge cycles of PANI/DBSA with carbon formulation. At low current, the IR drop is slight.

FIG. 35 depicts the discharged energy (J/Device) of various devices.

FIG. 36 depicts power (J/s) of PAC™ 1003, PANI/DBSA and their corresponding activated carbon formulations coin cells.

FIG. 37 depicts the comparison of charged and discharged energy for pellet coin cells at 1 mA, 1V.

FIG. 38 depicts the comparison of charged and discharged energy (J/Device) for pellet coin cells at 10 mA, 1V.

FIG. 39 depicts the comparison of charged and discharged energy for pellet coin cells at 100 mA, 1V.

FIG. 40 depicts the comparison of cycle stability of PANI/DBSA composite with that of activated carbon, colloidal graphite, and carbon black.

FIG. 41 depicts the effects of voltage variation on cycle stability.

FIGS. 42, 43, and 44 depict the effect of Au interfacial layer use in pellet coin cells at 10 mA, 1 mA, and 1V.

FIG. 45 depicts the effects of PTSA/TSAm on PAC™ 1003 coin cells' IR prop.

FIG. 46 is a bar graph depicting the effects of PTSA/TSAm and activated carbon on energy (J) of pellet-based coin cells.

FIG. 47 depicts the energy and specific capacitance (F/g) for pellet-based coin cells.

FIG. 48 depicts the power (J) for pellet-based coin cells-paste formulation.

FIG. 49 depicts (A) CV of electrochemically deposition of BEDOT-BBT on Pt button, (B) CV of electrochemically deposition of BEDOT-BBT on Au button, and (C) CV of electrochemically deposition of BEDOT-BBT onto ITO coated glass. Monomer concentration is 5 mM with 0.1 M in TBAP/DCM. All voltammograms represent stacked plots of 10 repeated scans (D) CV of electrochemically deposition of BEDOT-BBT on Au button. The monomer concentration is 1 mM with 0.1 M in TBAP/DCM. Voltammograms represent stacked plots of 20 repeated scans at a scan rate of 50 mV/sec.

FIG. 50 depicts the redox stability of Poly(BEDOT-BBT) on a Pt button in 0.1 M TABP/ACN.

FIG. 51 depicts the redox stability of Poly(BEDOT-BBT) on a Au button in 0.1 M TABP/ACN with (A) depicting a positive potential scan (P-dopable) and (B) depicting a negative potential scan (N-dopable).

FIG. 52 depicts the cyclic voltammetry of Poly(BEDOT-BBT) on a Au button working electrode in 0.1 M TBAP-PC solution at 50 mV/s.

FIG. 53 depicts the redox stability of Poly(BEDOT-BBT) on a Au button in 0.1 M TABP/ACN. (A) positive potential scan (P-dopable) (B) negative potential scan (N-dopable) at 50 mV/s. P(BEDOT-BBT) film made from CV method in monomer 1 mM TBAP/DCM.

FIG. 54 depicts the scan rate dependent CV of Poly(BEDOT-BBT) on Au button at various scan rate with (A) in 0.1 M TABP/ACN, (B) depicting the plot of specific area capacitance (mF/cm²) of poly(BEDOT-BBT) vs. scan rate, (C) in 0.1 M TBAP/PC, and (D) depicting the plot of specific area capacitance (mF/cm²) of poly(BEDOT-BBT) vs. scan rate under nitrogen bubble at RT.

FIG. 55 depicts the absorption spectra of BEDOT-BBT (ending near zero) UV-Vis in CH₂Cl₂, the absorption spectra of neutral Poly(BEDOT-BBT) (ending near 0.5) by applied constant potential at −0.4 V for 1 min., and oxidative poly(BEDOT-BBT) (ending just under 2) by applied constant potential at 0.5 V for 1 min. onto ITO-coated glass in 0.1 M TBAP/ACN.

FIG. 56 depicts the CV diagram when monomer concentration is 5 mM BEDOT-BBT with 0.1 M in TBAP/DCM with (A) CV of electrochemically deposition of BEDOT-BBT on stainless steel disk (φ=0.75 inch) in scan speed at 50 mV/s for 10 cycles and (B) CV of electrochemically deposition of BEDOT-BBT on stainless steel disk (φ=2.0 cm) in scan speed at 20 mV/s for 20 cycles.

FIG. 57 depicts the chronoamperometry diagram for solution stirring speed dependence of E-polymerization (top), a digital photograph of P(BEDOT-BBT) film deposited onto SS with Au interfacial layer (bottom). The applied potential was 0.7 V (vs. Ag/AgNO₃) under different time and solution speed.

FIG. 58 depicts a Chronoamperometry diagram for time dependence of electro-deposition onto a SS without Au layer under solution stirred at 600 rpm (top), with an applied potential at 0.7 V (vs. Ag/AgNO₃) for 120 sec (top left) and 240 sec (top right), and a digital photograph of P(BEDOT-BBT) film deposited onto a stainless steel substrate.

FIG. 59 depicts digital pictures showing the novel H-cell used for electro-polymerization of n-type Poly(BEDOT-BBT) (A & B, side and top views) and the deposited polymer film on stainless steel substrate carried out in the H-cell using chronoamperometry method at 0.8V for 240 sec (C). The polymer color was dark purplish-green.

FIG. 60 depicts the linear relationship plot for electro-deposited polymer amounts (mg) vs. charge (mC).

FIG. 61 depicts the chronoamperometry diagram of deposited polymer at applied 0.8 V until 50 mC in monomer conc. 1 mM in 0.1 M TBAP/DCM with (A) plot for charge vs. time (sec.) and (B) plot for current density (mA/cm²) vs. time (sec.) under argon at RT.

FIG. 62 depicts the CV diagram of potential between −0.4 and 0.5 V (P-type) in 0.1 M TBAP/PC under argon with (A) Scan rate dependent CV of Poly(BEDOT-BBT) film on Au IFL onto SS at various scan rate, (B) Plot of current (mA) at polymer oxidative potential vs. scan rate, and (C) Specific capacitance (F/g) of poly(BEDOT-BBT) vs. scan rate at RT.

FIG. 63 depicts N-type electro-characterization of P(BEDOT-BBT). (A) CV diagram of cyclic redox stability of Poly(BEDOT-BBT) on Au IFL SS in 0.1 M TABP/PC under argon. Cyclic potential ranges are between −1.4 and 0 V (N-type). (B) Scan rate dependent CV of Poly(BEDOT-BBT) film on Au IFL onto SS at various scan rates. (C) Plot of current (mA) at polymer reduction potential vs. scan rate. (D) Specific capacitance (F/g) of poly(BEDOT-BBT) vs. scan rate at RT.

### DETAILED DESCRIPTION OF THE PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

As used herein, the terms “electrically conductive polymer”, “intrinsically conductive polymer”, or “conductive polymer” refer to an organic polymer that contains polyconjugated bond systems and which can be doped with electron donor dopants or electron acceptor dopants to form a charge transfer complex that has an electrical conductivity of at least about 10⁻⁸ S/cm. It will be understood that whenever an electrically conductive polymer, ICP, or conductive polymer is referred to herein, it is meant that the material is associated with a dopant.

The term “dopant”, as used herein, means any protonic acid that forms a salt with a conductive polymer to give an electrically conductive form of the polymer. A single acid may be used as a dopant, or two or more different acids can act as the dopant for a polymer.

The term “film”, as used herein in conjunction with the description of a conductive polymer, means a solid form of the polymer. Unless otherwise described, the film can have almost any physical shape and is not limited to sheet-like shapes or to any other particular physical shape. Commonly, a film of a conductive polymer can conform to the surface of the dielectric layer of a solid electrolyte capacitor.

“Thermal stability”, as used herein to describe a material, means the ability of the material to resist decomposition or degradation when exposed to an elevated temperature for an extended period of time as measured by isothermal gravimetric analysis. The terms “improved thermal stability”, mean any improvement in the thermal stability of a material, no matter how small.

The term “mixture”, as used herein, refers to a physical combination of two or more materials and includes, without limitation, solutions, dispersions, emulsions, micro-emulsions, and the like.

Although any conductive polymer can be used in the present invention, examples of useful polymers include polyaniline (PANI), polypyrrole, polyacetylene, polythiophene, poly(phenylene vinylene), and the like. Polymers of substituted or unsubstituted aniline, pyrrole, or thiophene can serve as the conductive polymer of the present invention. In one embodiment, the conductive polymer is polyaniline.

Polyaniline occurs in at least four oxidation states: leuco-emeraldine, emeraldine, nigraniline, and pernigraniline. The emeraldine salt is a form of the polymer that exhibits a stable electrically conductive state. In the emeraldine salt form of polyaniline, the presence or absence of a protonic acid dopant (counterion) can change the state of the polymer, respectively, from emeraldine salt to emeraldine base. Thus, the presence or absence of such a dopant can reversibly render the polymer conductive or non-conductive. The use of protonic acids as dopants for conductive polymers, such as polyaniline, is known and simple protonic acids such as HCl and H₂SO₄, functionalized organic protonic acids such as p-toluenesulfonic acid (PTSA), or dodecylbenzenesulfonic acid (DBSA) result in the formation of conductive polyaniline.

Although electrical conductivity is often a key property of the final product of a conductive polymer, conductive polymers in their conductive forms are often difficult to process. Doped polyaniline, for example, is typically insoluble in all organic solvents, while the neutral form is soluble only in highly polar solvents, such as N-methylpyrrolidone. It has been found, however, that certain methods of synthesis, and the use of certain functionalized organic acid dopants, rendered electrically conductive polyaniline salt more soluble in organic solvents. See, e.g., U.S. Pat. Nos. 5,863,465 and 5,567,356 (use of hydrophobic counterions in emulsion polymerization with polar organic liquids), and WO 92/22911 and U.S. Pat. Nos. 5,324,453 and 5,232,631, (use of counterions having surfactant properties in emulsion polymerization with non-polar organic liquids).

PANI is an ICP considered a suitable candidate for application as electrode material in energy storage devices including supercapacitors. PANI exhibits good stability and film-forming capability. Additionally, PANI exhibits good electrochemical properties such as faradaic capacitance and charge-discharge capability. Doping of PANI is an important step in forming polymer chains with improved electrical conductivity. Primary dopants have the ability to promote the formation of polarons/bipolarons responsible for creating delocalized electrons along the length of the conducting polymer chain, thereby establishing electrical conductivity along the chain length. Improved conductivity may be obtained with defect-free, or low-defect, chains (defects=lack of conjugation), with a good π-π overlap for conduction along the polymer chain length.

Secondary doping of PANI can be performed to overcome the limitations of primary-doped PANI in achieving metal-like conductivity. In some embodiments, the secondary doping may be conducted by washing the PANI film to remove excess, unbound primary dopant from the polymer, inducing transformation of the coil-like conformation of polymers in the film to an expanded-chain formation, and formation of close-packing of polymer chains upon heat treatment, which promotes π-π stacking of phenyl rings in PANI and the dopant and hydrogen bonding of hydroxyl groups in dopants with amine and imine sites in PANI.

PAC™ 1003, a commercial product of Crosslink, is a primary-doped polyaniline solution that employs dinonyl naphthalene sulfonic acid as the primary dopant. PAC™ 1003 has a room temperature electrical conductivity of 0.16 S/cm. PAC™ 1007, also a commercial product of Crosslink, is a solution “in-situ” secondary doped PAC™ 1003 with a room temperature electrical conductivity of 15-20 S/cm. In some embodiments, the shelf-life of PAC™ 1007 may be limited due to an undesirable gelation effect believed to be caused by possible crosslinking of PANI chains by the secondary dopant, sulfonyl diphenol (SDP).

In one aspect, the present invention is a novel monomer that may be polymerized to form a novel ICP. Scheme 1 illustrates the synthesis of the novel monomer, bisethylene dioxythiophene-bisbenzothiadiazole (BEDOT-BBT), compound 7 from the starting material benzothiadiazole (BT), compound 1. Commercially available BT in HBr acid (48%) may be reacted with a bromine compound to yield dibromo-BT, 2 (bromination reaction). Next, compound 2 may be nitrated, for example with H₂SO₄/HNO₃. The dinitro-dibromo-BT 4 thus obtained may be of low yield (23%) due to side reactions that yield mono-nitration and tribromo compounds plus ring decomposition. EDOT-SnBu₃ may then be mixed with compound 4 in the presence of a catalyst, for example Pd catalyst, to yield the BEDOT-BT-(NO₂)₂, compound 5 (Stille coupling reaction). Reduction of compound 5 with iron powder in acetic acid gives compound 6 (greenish-yellow powder). The final BEDOT-BBT compound 7 may be obtained from a ring closing reaction with N-thionylaniline in pyridine.

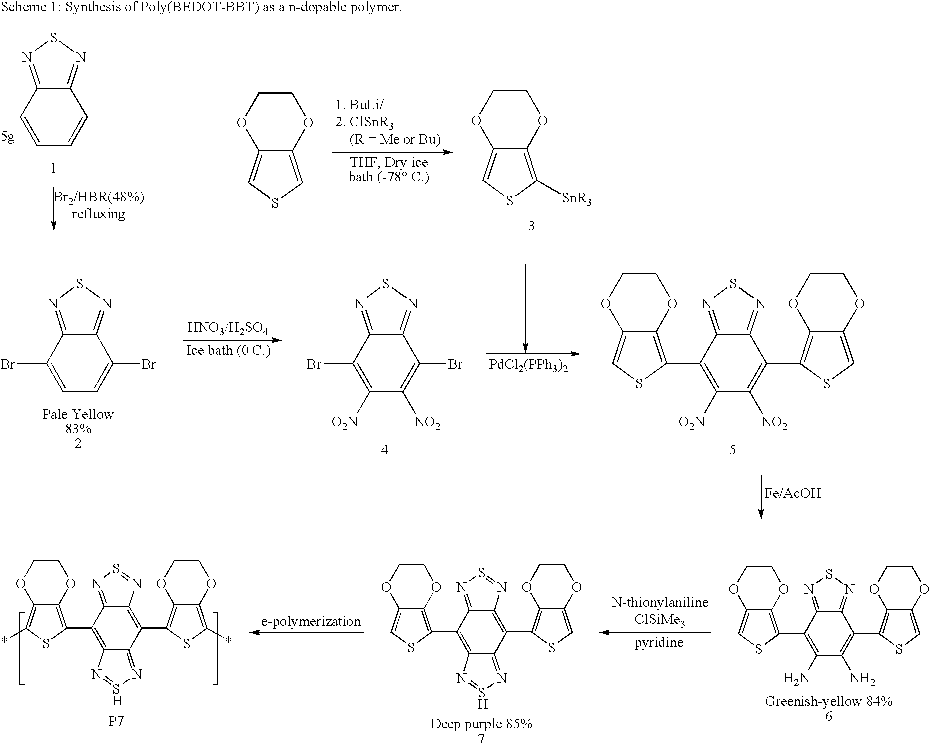

In the above scheme (Scheme 1), the nitration reaction gives a very low yield (20%). To improve the yield, an alternative route as referenced in J. Org. Chem. Vol 38, No 25, 1973, page 4243 (equation 1) may be utilized.

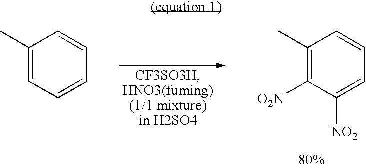

The n-dopable Poly(BEDOT-BBT) may then be doped according to one or more methods known in the art. Additionally, the n-dopable Poly(BEDOT-BBT) described herein may be also, or alternatively, be doped by one or more of the methods discussed below.

In some aspects, it may be desirable to form the n-dopable Poly(BEDOT-BBT) into films, such as the other ICP films discussed herein.

In one aspect, the present invention is directed to novel methods of doping intrinsically conductive polymer films. In some embodiments, the novel methods are methods of secondary doping of ICP films. In other embodiments, the novel methods are methods of tertiary doping of ICP films. In yet other embodiments, the same methods may be used for both secondary and tertiary doping of ICP films. In some embodiments, the methods are particularly useful with respect to PANI films.

It may be desirable, in some embodiments, to clean a primary doped ICP film prior to conducting a secondary doping. In some embodiments, the primary doped ICP film may be cleaned by methods known in the art including, but not limited to, solvent washing or rinsing.

In another embodiment, the invention is a novel method of cleaning a primary doped ICP film. The novel method includes vapor cleaning a primary doped ICP film. In this embodiment, a primary doped ICP film may be vapor cleaned to enhance the electrical conductivity of primary doped ICP films. Suitable vapors include one or more vapors of Thymol, Carvacrol, isopropyl phenol, diisopropyl phenol, and meta-cresol.

Vapor-cleaning may be understood as penetration of non-toxic phenol vapor into the nano-porous film network of the ICP film, resulting in the removal of un-bound dopants and residual solvent. This penetration may result in the creation of nanoporous voids to accommodate incorporation of secondary dopants.

In one embodiment, the invention is a film dip-doping method of secondary doping of PANI films. The dip-doping method may be conducted alone or in combination with any of the cleaning methods discussed above, including the presently described vapor-cleaning method.

The present embodiment improves on PAC™ 1007 by reducing and/or eliminating the undesirable gelation effect of PAC™ 1007 discussed above. Additionally, the method produces uniform PANI film samples having a thickness of from about 0.15 μm to about 0.35 μm demonstrating good flexibility. Additionally, the method produces improved electrical conductivity over both PAC™ 1003 and PAC™ 1007. In the present embodiment, the film dip-doping may be conducted by dipping primary-doped ICP films into a mixture of an organic solvent and a protonic acid for a suitable period of time. In some embodiments, the film may be dipped for a period of from about 1 second to about 120 seconds. In other embodiments, the time can be from about 5 seconds to about 60 seconds. In still other embodiments, the time can be from about 10 seconds to about 30 seconds.

During the contacting process, the temperature of the film and of the mixture can be from about 5° C. to about 50° C., from about 10° C. to about 30° C., or about room temperature.

The protonic acid can be any protonic acid that can act as a dopant for the conductive polymer. The protonic acid can be the same as the primary dopant, or it can be a different protonic acid, or it can be a mixture of two or more protonic acids, any one of which can be the same or different than the primary dopant.

In an embodiment of the present method, the protonic acid can act as a dopant that when combined with a conductive polymer not only provides electrical conductivity but also improves the thermal stability of the conductive polymer.

Examples of materials that are suitable for use as the protonic acid of the present invention include, without limitation, 4-sulfophthalic acid (4-SPHA), p-toluenesulfonic acid (PTSA), benzenesulfonic acid (BA), phenylphosphonic acid (PA), phosphoric acid (H₃PO₄), and camphorsulfonic acid (CSA), among others. Further examples of acids that are useful as the protonic acid are described in U.S. Pat. No. 5,069,820. In one embodiment, the protonic acid comprises an organic sulfonic acid. The acid can have one, two, three, or more sulfonate groups. An example of a suitable organic sulfonic acid is a compound having the formula R₁HSO₃, where R₁ is a substituted or unsubstituted organic radical.

Another example of a material that is suitable for use as the protonic acid dopant is a compound having the formula:

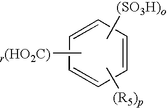

wherein: o is 1, 2 or 3; r and p are the same or are different and are 0, 1 or 2; and R₅ is alkyl, fluoro, or alkyl substituted with one or more fluoro or cyano groups.

In the previous structure, it is also suitable when: o is 1 or 2; r and p are the same or are different and are 0 or 1; and R₅ is alkyl, fluoro, or alkyl substituted with one or more fluoro or cyano groups.

In one embodiment, the protonic acid dopant comprises p-toluenesulfonic acid. In another embodiment, the protonic acid dopant comprises a mixture of p-toluenesulfonic acid (PTSA) and p-toluenesulfonamide (TSAm).

Generally, an organic solvent may be selected so that it will dissolve both the protonic acid and the primary dopant. Therefore, the organic solvent should be at least mildly polar, such as butylcellosolve (dielectric constant (DC)=9.4), n-butanol (DC=17.8), and the like, which are sufficiently polar to dissolve, for example, p-toluenesulfonic acid and sufficiently non-polar to dissolve, for example, dinonylnaphthalenesulfonic acid.

Examples of suitable organic solvents of the present invention include n-butanol, butylcellosolve, and mixtures thereof.

In the present method, the mixture of the organic solvent and protonic acid generally comprises the protonic acid in an amount that is selected to improve the thermal stability of the conductive polymer film and to decrease the loss of electrical conductivity caused by thermal stress (which reduces the shift in equivalent series resistance (Δ-ESR) in capacitors).

Typically, the mixture of the organic solvent and protonic acid can comprise the protonic acid in an amount of from about 0.5% to about 25%. The mixture can also contain the protonic acid in an amount of from about 1% to about 15%, or from about 3% to about 7%, all in percent by weight.

Although the mixture of the organic solvent and protonic acid can further comprise almost any other additive that increases the effectiveness of the contacting process, it is typically free of monomer of the conductive polymer and free of the conductive polymer before it contacts the doped conductive polymer film. Optionally, the mixture can consist essentially of the organic solvent and protonic acid.

In one embodiment, the concentration of the protonic acid in the organic solvent and the time of contacting the mixture with the conductive polymer film (the contacting conditions) are selected to improve the thermal stability so that weight loss of the treated electrically conductive polymer film in 120 minutes at 200° C. is less than about 20%, and that loss of electrical conductivity is under 30% after the same treatment. Alternatively, the contacting conditions are selected so that the weight loss is less than about 10%, and that loss of electrical conductivity is under 20%, or that weight loss is less than about 5%, and that loss of electrical conductivity is under 10% after the same treatment.

After secondary and/or tertiary doping, the conductivity of the ICP films may be increased by annealing the films. The films may be annealed by one or both of mechanical stretch annealing and chemical annealing. Without being bound by theory, it is believed that mechanically annealing the films results in improved alignment and orientation of the polymer chains, thereby creating pathways for electron movement. Additionally, and without being bound by theory, it is believed that chemical annealing results in enhanced formation of crystalline domains in the doped ICP films. The combination of mechanical and chemical annealing may result in the formation of uniaxially aligned crystalline domains within the film, allowing increased electron movement in the film. This increased electron movement results in improved conductivity of the films.

Mechanical annealing may be conducted on secondary or tertiary doped ICP films by stretching the films. In some embodiments, the films may be annealed at about room temperature. In other embodiments, it may be desirable to heat the film prior to annealing. Where the film is heated prior to mechanical annealing, it may be heated to a temperature of from about 50° C. to about 80° C., in some embodiments from about 55° C. to about 75° C., and in other embodiments from about 60° C. to about 70° C.

The film may be heated by methods of heating known in the art including, but not limited to, IR heating, convection heating, thermal oven heating, gas heating, solar heating, and combinations thereof.

The film may be subjected to mechanical stress to induce mechanical annealing. In some embodiments, the mechanical stress may be one or more of stretching, twisting, bending, pressing, and other mechanical deformations. When the film is stretched to induce mechanical annealing, the film may be stretched to a length greater than 125% of the original length of the film, in some embodiments greater than 145% of the original length of the film, and in still other embodiments greater than 150% the original length of the film.

When the film is heated prior to stretching, it may be desirable to maintain the film at an increased temperature during stretching. The film may also be allowed to cool to temperatures below the stretching temperature prior to the release of the mechanical stress. In some embodiments, it may be desirable to reduce the temperature to about room temperature prior to release of the mechanical stress.

The mechanical stress may be parallel, i.e. in opposing directions, perpendicular, i.e, in directions at right angles to one another, at any angle in between parallel and perpendicular, and biaxial stretching.

The conductive ICP films may also be subject to chemical annealing. In some embodiments, the chemical annealing may serve as a tertiary doping method. Chemical annealing, where utilized in conjunction with mechanical annealing, may occur prior to, during, or after the mechanical annealing process discussed above.

The conductive ICP films of the present invention may be chemically annealed by immersing the films in a solution of protonic acid and organic solvent. Protonic acids and organic solvents contemplated as useful in the present chemical annealing process may be selected from those protonic acids and organic solvents discussed above.

The ICP films may be immersed for a period of time ranging from about 10 seconds to about 120 seconds, in some embodiments for a period of time ranging from about 20 seconds to about 50 seconds, and in some embodiments for about 30 seconds.

The solution for chemical annealing may contain from about 1% to about 10% protonic acid, in some embodiments from about 2% to about 8%, and in other embodiments from about 3% to about 7% protonic acid in organic solvent. Additionally, the solution for chemical annealing may include more than one protonic acid and/or more than one organic solvent.

Where more than one protonic acid is included in the solution for chemical annealing, the ratio of protonic acids may be from about 1:1 to about 3:1 and in some embodiments from 1.5:1 to about 2.5:1.

When each of the above doping methods are utilized in conjunction with one another, the conductivity of the resulting ICP film may be increased by three or more orders of magnitude.

Primary, secondary, and/or tertiary doped ICP films formed in accordance with the present invention may be utilized in a variety of applications in which metal-like conductivity is desirable. For example, the present films may be utilized in electromagnetic interference shield coatings for aircrafts and vehicles, corrosion inhibiting coatings for structures, smart sensors for air-crafts and other composite materials, and/or portable consumer electronics (for example, back-up power for computers, electronic fuses, and organic LEDs). Additionally, the present films may find application in energy storage applications, such as supercapacitors, batteries, and combination supercapacitor/batteries.

In a non-limiting example, the ICP films of the present invention may be used as ICP electrodes in supercapacitor devices. The ICP electrodes may be tailored to provide the needed conductivity, range of voltage, storage capacity, reversibility and chemical and environmental stability required for supercapacitors. ICP-based supercapacitors may be separated into four different categories:
1. Type I supercapacitors are a symmetric construction of supercapacitor with the same positively doped (p-doped) ICP used on both electrodes. These supercapacitors have limited voltages due to the overoxidation of the polymer to about 0.75-1.0 V which limits its energy and power densities.
2. Type II supercapacitors use different p-doped ICPs on each electrode.
3. Type III supercapacitors use the same ICP in a negatively-doped (n-doped) form for one electrode and the p-doped form for the other.
4. Type IV supercapacitors are also an asymmetric construction like Type II but different ICPs are used for the n- and p-doped electrodes. Because Type III and IV supercapacitors both use n- and p-doped polymers they are sometimes discussed together.

The energy and power densities of the various categories of supercapacitors may be calculated as follows:

$$Energy density ( ED , Wh \text{/} Kg ) = \frac{1 \times V \times Td}{2 \times m \times 3600}$$

$$Power density ( PD , W \text{/} Kg ) = \frac{ED}{Td} \times 3600 ,$$

where I is current (amps), V is potential (volts), Td is discharging time (seconds), m is total mass (grams) of polymer electrode.

Polyaniline may be useful in several applications due to its electrochemical stability in various electrolytes. There have been limitations to its use in supercapacitor devices, however, due to high equivalent series resistance (ESR) and irreversibility, resulting in poor device performance. Previous approaches for using PANI in supercapacitor devices typically focused on utilizing conductive polymers on substrate materials such as carbon nanotubes (CNT) for improved charge transfer and reduced ESR, enabling high charge-discharge rates. CNTs, however, are expensive and difficult to synthesize and modify as necessary to utilize in such applications.

In the present invention, ICP films may be utilized in supercapacitors, demonstrating high energy and power densities without the absolute need for high-conductive substrates such as CNT. Without being bound by theory, it is believed a structure property correlation exists, wherein highly conductive polymer chains exhibiting crystalline domains are formed by one or more of the processes described above, translating to an enhancement in supercapacitor device performance in terms of energy and power densities and cycle life. Additionally, the present invention includes the fabrication of Type I supercapacitors using an interfacial layer (IFL) that provides efficient charge transfer between a stainless steel current collector and ICP electrode, reducing the ESR even further.

In some embodiments, the ICP films may be pelletized prior to their inclusion as electrodes. In other embodiments, the ICP films may be in the form of a paste.

It may be desirable, in some embodiments, to include carbon additives to the present ICP electrodes. Such carbon additives may include, but are not limited to, one or more of activated carbon, carbon black, and other carbon additives known in the art.

Additionally, the present ICP films may be utilized in any of Type I, II, III, and IV supercapacitors. Moreover, it may be desirable, in some embodiments, to utilize different ICP films in the same supercapacitor.

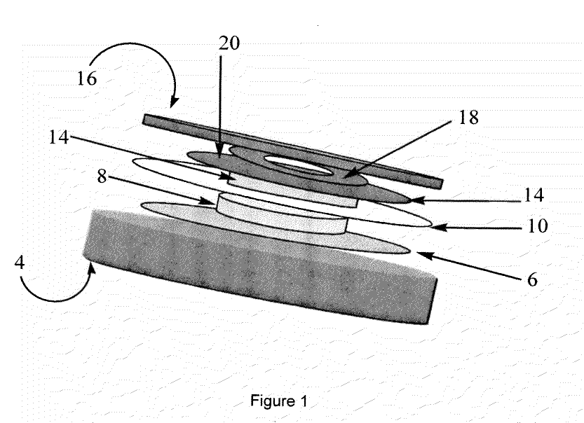

FIG. 1 shows a schematic of an exemplary Type I coin cell supercapacitor device 2 in accordance with the present invention. The schematic depicts a substrate 4 with an optional spacer 6 in contact with the substrate 4. The first electrode 8 may comprise the present ICP films. Optionally, as discussed above, the first electrode 8 may include one or more carbon additives. In some embodiments, it may be desirable to include other additives, such as those discussed above, in the first electrode 8. The present supercapacitors 2 also include an electrolyte 10. In some embodiments, it may be desirable to include one or more optional separators (not shown) between the electrolyte 10 and the first electrode 8. A second electrode 14 is also present. The second electrode 14 may be the same as or different than the first electrode 8. The second electrode 14 and first electrode 8 are typically on opposing sides of the electrolyte 10 in the exemplary supercapacitor depicted in FIG. 1. The supercapacitor 2 also includes a second substrate 16. Optionally, the supercapacitor may also include a spring 18 and/or additional spacers 20.

Exemplary materials contemplated as useful spacers, where utilized, are polytetrafluoroethylene (PTFE), polypropylene, polycarbonate, polyvinyl chloride, other electrically insulating polymers, ceramics, and combinations thereof.

Exemplary electrolytes contemplated as useful in accordance with the present invention are one more of 1-ethyl-3-methyl-imidazolium bis(trifluoromethanesulfonyl)imide (EMI-IM), lithium-bis(trifluoromethanesulfonyl)imide (Li-IM), silcotungstic acid, and combinations thereof.

In some embodiments it may be desirable to include a solvent, such as propylene carbonate, acetonitrile, dimethyl formamide, butryl nitrile, and combinations thereof, in the electrolyte.

In some embodiments, it may be desirable to blend a polymer, such as polyvinyl alcohol, with an ionic material to form the present electrolytes.

Additionally, in some embodiments, it may be desirable to include an interfacial layer in the supercapacitor adjacent the electrode. Exemplary materials contemplated as useful in the optional interfacial layer are one or more of gold, platinum, chromium, titanium, iridium, and combinations thereof. Where utilized, the interfacial layer is typically located between an electrode and spacer. In some embodiments, the interfacial layer may be useful to enhance mechanical stability of the ICP electrode, enhance charge transfer efficiency of the ICP electrode, and/or enhance the electric charge dissipation of the ICP electrode, allowing operation at higher potentials.

It may also be desirable to utilize a support for the electrodes of the present invention. Supports may be useful to conduct energy away from the electrode. For example, the present ICP electrodes may be deposited on a disk, such as a stainless steel (SS) disk. Supports contemplated as useful in accordance with the present invention are one or more of stainless steel, aluminum, copper, carbon, other metal alloys, and combinations thereof.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples.

### Example 1

This example sets forth a method of preparation of PAC™ 1003 (polyaniline-DNNSA) film and PAC™ 1007 (polyaniline-DNNSA-SDP) film.

Primary doped polyaniline solutions of PAC™ 1003 solutions were obtained from Crosslink. These solutions include polyaniline and DNNSA with solvent. The solvents in the solution are xylene and butylcellosolve (BCS). The solid content of PAC™ 1003 is about 45%. The PAC™ 1003 is diluted with xylene/BCS (1/1 w/w) to about 15% for fabricating thin films via spin-coating and drop casting (PAC™-15% film). All examples herein utilize PAC™ 1003-15% film and will be referred to as PAC™ 1003 film unless specifically indicated otherwise.

Primary and secondary doped polyaniline solution used herein was received as PAC™ 1007 solution manufactured by Crosslink. The solution includes polyaniline, DNNSA, SDP, and solvents. The solvents are xylene and BCS. The solid content of PAC™ 1007 was about 25%. The PAC™ 1007 was diluted with xylene/BCS (1/1 w/w) to about 15% for fabricating thin films via spin-coating and drop casting (PAC™ 1007-15% film). All examples herein utilize PAC™ 1007-15% film and will be referred to as PAC™ 1007 film unless specifically indicated otherwise.

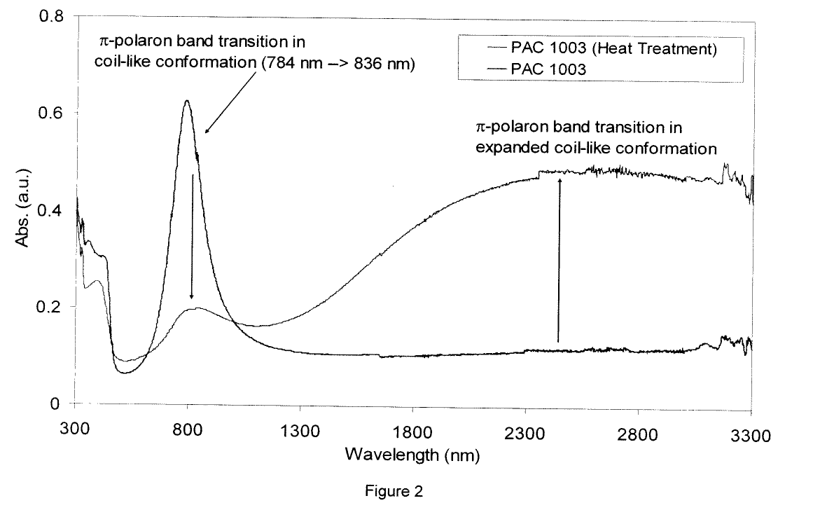

Thin film samples for UV-Vis-NIR spectra were prepared on a glass slide (1 inch by 1 inch) using polymer solutions (3 mL). The glass slides were cleaned by dipping them into deionized water, acetone, and isopropanol. The standard absorption profile of PAC™ 1003 samples that have solids content of about 15 w/w % is shown in FIG. 2. Spin coating of PAC™ 1003 was carried out at a spin coating speed of 6000 rpm for about 30 seconds. The absorption peak at about 780 nm assigned to polaron band in coil-like conformation of PANI chains was found to disappear upon heat-treatment at 150° C. for 30 minutes and a broad bad (i.e., free carrier absorption tail) appears in the NIR region (1000 to 3300 nm) indicating the transformation of PANI chains into an expanded chain conformation, i.e., film formation.

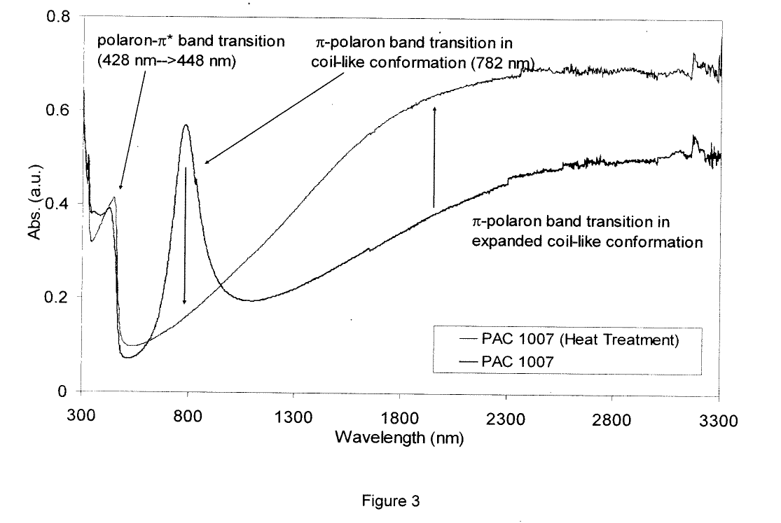

FIG. 3 shows the UV-Vis-NIR spectral curves of PAC™ 1007 films formed in accordance with the above spin-coating process before and after heat-treatment at 150° C. for 30 minutes. A broad band in the NIR region indicates the presence of PANI chains in expanded chain conformation, i.e., film formation.

Electrical conductivity of all films in the examples was measured at room temperature using a 1000 Angstrom thick chrome-gold bilayer as the contact bus on a four probe configuration. The film thickness measurement was conducted using atomic force microscopy (AFM) with the reported thickness being an average of three spots of measurement on each sample. At a minimum, three samples of each formulation were prepared for thickness and electrical conductivity measurements.

### Example 2

This example sets forth a method of doping of PAC™ 1003 films and PAC™ 1007 films with PTSA-BCS solutions.

The method consists of dipping the PAC™ 1003 film or PAC™ 1007 film into a PTSA-BCS solution for 30 seconds. Upon doping, the film thickness is reduced from between 400 and 1000 nm to from about 150 to about 300 nm. Gentle air-blowing was performed on the wet films followed by heat treatment in an oven at 150° C. for about 30 minutes to obtain high quality films.

The electrical conductivity of the PTSA-doped PAC™ 1003 films after heat treatment is set forth in Table 1. The PTSA-doped PAC™ 1003 film sample with film thickness of 209 nm recorded a maximum electrical conductivity of 334 S/cm. PAC™ 1003 films without the PTSA treatment recorded an electrical conductivity of 15-20 S/cm.

TABLE 1
Four probe electrical conductivity of PTSA-doped
PAC ™ 1003 films after heat treatment measured
at room temperature using chrome-gold contact bus.

| | Conc. Of PTSA | Film thickness | Conductivity |
|---|---|---|---|
| Dopants | in BCS (w/v %) | (μm) | (S/cm) |
| None | 0 | 0.438 | 0.16 |
| PTSA | 5.0 | 0.182 | 225.07 |
| | | 0.209 | 333.92 |
| | | 0.272 | 182.55 |

The electrical conductivity of the PTSA-doped PAC™ 1007 films after heat treatment is set forth in Table 2. The PTSA-doped PAC™ 1007 film sample with film thickness of 249 nm recorded a maximum electrical conductivity of 187 S/cm. PAC™ 1007 films without the PTSA treatment recorded an electrical conductivity of 15-20 S/cm.

TABLE 2
Four probe electrical conductivity of PTSA-doped
PAC ™ 1007 films after heat treatment measured
at room temperature using chrome-gold contact bus.

| | Conc. Of PTSA | Film thickness | Conductivity |
|---|---|---|---|
| Dopants | in BCS (w/v %) | (μm) | (S/cm) |
| None | 0 | 0.668 | 23.2 |
| | | 0.856 | 15 |
| PTSA | 5.0 | 0.249 | 187.4 |
| | | 0.466 | 123 |

### Example 3

This example sets forth a method of doping PAC™ 1003 films and PAC™ 1007 films in PTSA-TSAm-BCS solutions.

The film was doped into the PTSA-TSAm-BCS solution for 30 seconds. Upon doping, the PAC™ 1003 film thickness was reduced from between 600-1000 nm to from about 150 to about 350 nm, depending on the post-treatment conditions. Gentle air-blowing was performed on the wet films, followed by heat treatment in an oven at 150° C. for about 30 minutes.

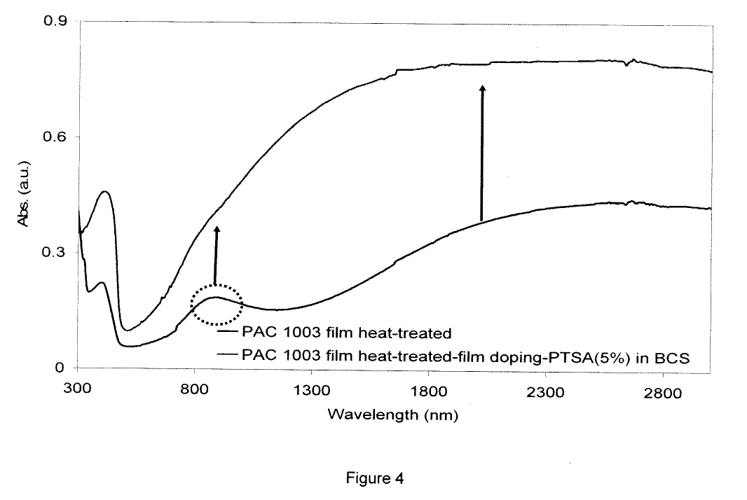

The electrical conductivity of the PTSA-TSAm-doped PAC™ 1003 films after heat treatment is set forth in Table 3. The PTSA-TSAm-doped PAC™ 1003 film sample with film thickness of 175 nm formed using a dopant formulation solution of 5% PTSA and 0.5% TSAm recorded a maximum electrical conductivity of 270 S/cm. Increase in the concentration of TSAm to 5% in the dopant formulation solution did not improve the electrical conductivity or enhance the film quality. PAC™ 1003 films without the PTSA-TSAm treatment recorded an electrical conductivity of 0.16 S/cm (See FIG. 4).

TABLE 3
Four probe electrical conductivity of PTSA-TSAm-doped
PAC ™ 1003 films after heat treatment measured
at room temperature using chrome-gold contact bus.

| | Conc. Of PTSA- | | |
|---|---|---|---|
| | TSAm in BCS | Film thickness | Conductivity |
| Dopants | (w/v %) | (μm) | (S/cm) |
| None | 0-0 | 0.438 | 0.16 |
| PTSA-TSAm | 5.0-0.5 | 0.175 | 270.55 |
| | | 0.187 | 241.98 |
| | | 0.226 | 230.41 |
| | | 0.318 | 165.22 |
| | 5.0-5.0 | 0.237 | 218.5 |

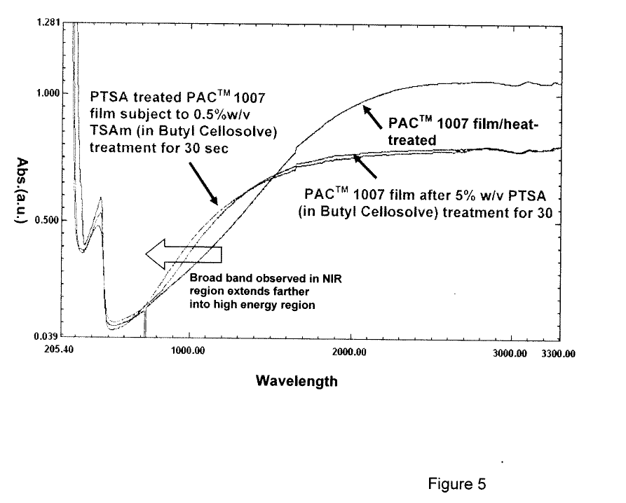

The electrical conductivity of the PTSA-TSAm-doped PAC™ 1007 films after heat treatment is set forth in Table 4. The PTSA-TSAm-doped PAC™ 1007 film sample with film thickness of 1000 nm formed using a dopant formulation solution of 2.5% PTSA and 0.25% TSAm recorded a maximum electrical conductivity of 400 S/cm. PAC™ 1007 films without the PTSA-TSAm treatment recorded an electrical conductivity of 15-20 S/cm (See FIG. 5).

TABLE 4
Four probe electrical conductivity of PTSA-TSAm-doped
PAC ™ 1007 films after heat treatment measured
at room temperature using chrome-gold contact bus.

| | Conc. Of PTSA- | | |
|---|---|---|---|
| | TSAm in BCS | Film thickness | Conductivity |
| Dopants | (w/v %) | (μm) | (S/cm) |
| None | 0-0 | 0.668 | 23.2 |
| | | 0.856 | 15 |
| PTSA-TSAm | 2.5-0.25 | 0.270 | 363 |
| | | 0.356 | 314 |
| | | 0.360 | 386 |
| | | 1.043 | 398 |

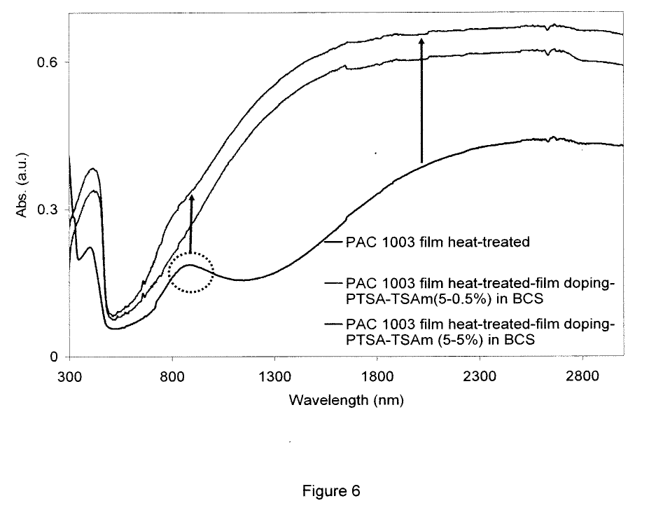

FIG. 6 shows the absorption curves of PAC™ 1003 films and PTSA-TSAm-doped PAC™ 1003 films. The absorption peak at around 780 nm assigned to polaron band in coil-like conformations of PANI chains was found to disappear upon PTSA-TSAm doping and a broad band appears in the NIR region, indicating the transformation of PANI chains to an expanded chain conformation.

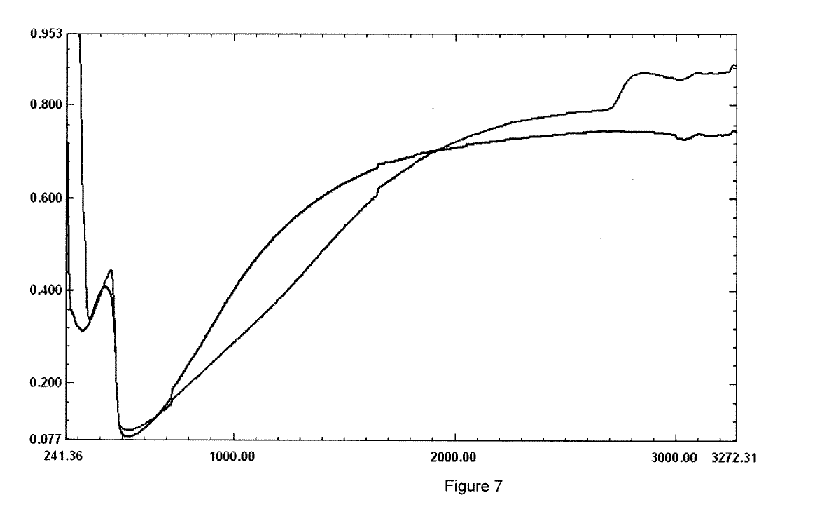

FIG. 7 shows the absorption curves of PAC™ 1007 films and PTSA-TSAm-doped PAC™ 1007 films. The broad band present in the NIR region appears to extend into the high energy region upon PTSA-TSAm doping, indicating an enhancement in crystalline domains and close-packing of PANI chains in the film.

### Example 4

In this example, free standing PAC™ 1003 and PAC™ 1007 films are produced by casting 1.5 mL of formulated solution onto a glass substrate, followed by air drying overnight in a fume hood and heat-treatment in an oven for 30 minutes at 150° C. The films were dipped into a doping solution of PTSA/BCS (5 w/v %) or PTSA/TSAm/BCS (5/0.5 w/v %) for 30 seconds and cut as a free standing film using a razor blade. Free standing PAC™ 1007 films, especially those made using PTSA dopant solutions, were found to be brittle. Without being bound by theory, it is believed the brittleness was due to high crystallinity induced by the crystalline PTSA compound being added to the already crystalline PAC™ 1007 films. Similarly, it is believed that small amounts of TSAm, if present, may bring about a plasticizing effect in the sample, thereby making the films flexible without adverse effects on electrical conductivity.

### Example 5

This example sets forth an exemplary method of the vapor-cleaning method discussed above. PAC™ 1003 film was exposed to vapors of thymol, carvacrol, isopropyl phenol, or diisopropyl phenol for 30 minutes. A beaker containing the solution to be vaporized was placed on a hot plate with a surface temperature controlled to 150° C. for thymol, 100° C. for carvacrol, or 130° C. for same change as above. Upon vapor-cleaning, the film thickness is reduced from about 400-1000 nm to from about 150 to about 500 nm. The vapor-cleaned sample was subsequently heat-treated in an oven at 150° C. for about 30 minutes. Next, the vapor-cleaned PAC™ 1003 film was dip-doped in PISA (5% w/v in BCS) solution for 30 seconds or PTSA/TSAm [1:1 v/v (5% w/v of PTSA+0.5% w/v TSAm in BCS)] solution for about 30 seconds. Upon doping, the film thickness reduced to from about 150 nm to about 300 nm. Gentle air-blowing was performed on the wet films followed by heat treatment in an oven at 150° C. for about 30 minutes.

The electrical conductivity of vapor-cleaned PAC™ 1003 films is shown in Tables 5-7, along with sample film thickness. The carvacol and thymol vapor-treated PAC™ 1003 film samples recorded a maximum electrical conductivity of 48.5 S/cm and 25.2 S/cm, respectively.

TABLE 5
Four-probe electrical conductivity of PAC ™ 1003
films vapor-cleaned with thymol and carvacrol followed
by film dip-doping in PTSA and PTSA-TSAm dopant solutions.

| | Film thickness | Electrical Conductivity |
|---|---|---|
| Dopants | (nm) | (S/cm) |
| None | 438.0 | 0.16 |
| Thymol | 232.2 | 25.2 |
| Carvacrol | 199.8 | 48.5 |
| PTSA | 209.0 | 333.92 |
| Thymol/PTSA | 169.14 | 382.92 |
| Carvacol/PTSA* | 197.39 | 611.85 |
| PTSA-TSAm | 175.0 | 270.55 |
| Thymol/PTSA-TSAm | 207.39 | 825.67 |
| Carvacrol/PTSA-TSAm | 192.55 | 449.26 |

*No clean film surfaces observed

TABLE 6
Four-probe electrical conductivity (as a function of
film thickness) of PAC ™ 1003 films vapor-
cleaned with thymol followed by PTSA and PTSA/TSAm doping.

| Thickness | Conductivity | Sheet resistance |
|---|---|---|
| (nm) | (S/cm) | (Ohm/Sq.) |
| 59.13 | 506.37 | 334 |
| 177.63 | 642.66 | 87.6 |
| 207.39 | 825.67 | 58.4 |
| 220.57 | 914.04 | 49.6 |
| 238.50 | 895.91 | 46.8 |
| 254.21 | 1035.2 | 38.0 |
| 255.85 | 1016.8 | 38.0 |
| 459.47 | 710.32 | 30.6 |

TABLE 7
Four-probe electrical conductivity of PAC ™ 1003 films
vapor-cleaned with isopropanol (IPP) or diisopropanol (DIPP)
followed by film dip-doping in PTSA and PTSA-TSAm dopant solutions.

| | Film thickness | Electrical Conductivity |
|---|---|---|
| Dopants | (nm) | (S/cm) |
| None | 438.0 | 0.16 |
| IPP | 472.7 | 0.96 |
| DIPP | 286.5 | 6.02 |
| PTSA | 209.0 | 333.92 |
| IPP/PTSA | 176.85 | 614.62 |
| DIPP/PTSA* | 154.5 | 305.31 |
| PTSA-TSAm | 175.0 | 270.55 |
| IPP/PTSA-TSAm | 290.0 | 400.93 |
| DIPP/PTSA-TSAm | 229.5 | 287.45 |

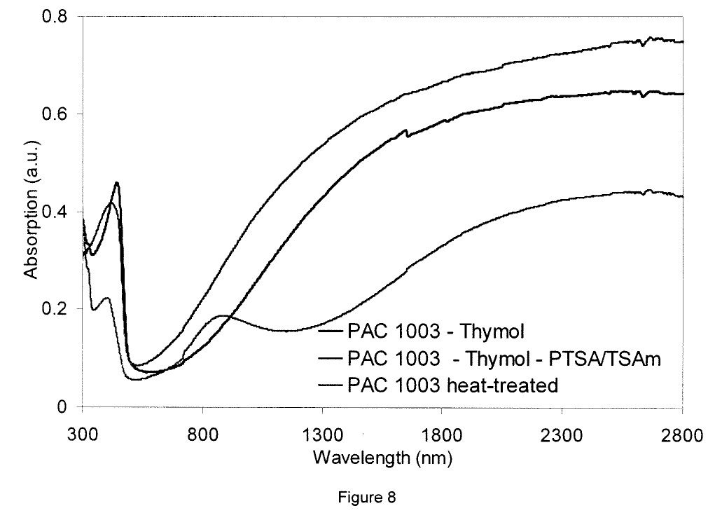

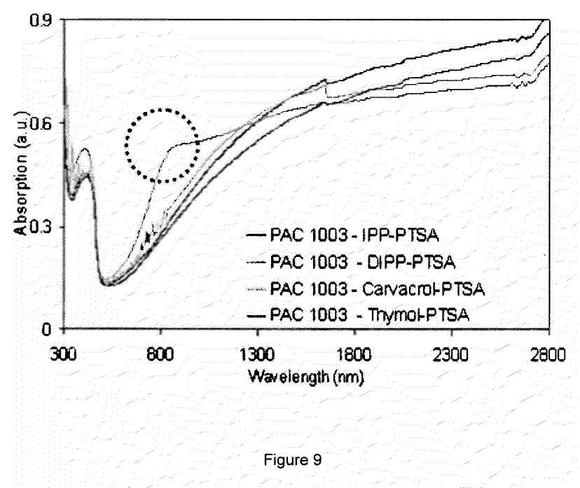

FIG. 8 shows the absorption curves of PAC™ 1003 film doped with PTSA-TSAm with an intermediate vapor-cleaning with thymol. The absorption peak at around 800 nm assigned to polaron band in coil-like conformation of PANI chains was found to disappear upon vapor-cleaning with thymol and instead a broad band appears in NIR region, indicating the transformation of PANI chains into an expanded chain conformation. As can be seen in FIG. 9, similar trends were observed for PAC™ 1003 films that involve an intermediate vapor-cleaning step with other vapors.

### Example 6

In this example, a typical method for mechanical annealing of PANI films is set forth. The PANI film sample was heated to 65° C. using an IR lamp as the heating source followed by mechanical stretching to 140% of the original length. The film was held in the stretched form for about 5 minutes. The rate of stretching is not critical and can range from about 0.1 to about 5 cm/min. After stretching, the sample was cooled to room temperature and the mechanical stress was released. Films subjected to mechanical annealing preserved adhesion to Teflon and integrity even after stretching. Parallel and perpendicular resistances (with respect to stretch direction) were measured using four-probe conductivity equipment.

### Example 7

In this example, a typical method for chemical annealing of PANI films is set forth. The PANI films were subjected to chemical annealing by dipping the films in 5% w/v PTSA in BCS or a 1:1 v/v of (5% w/v PTSA in BCS+0.5% w/v TSAm in BCS) for a 30 second time period.

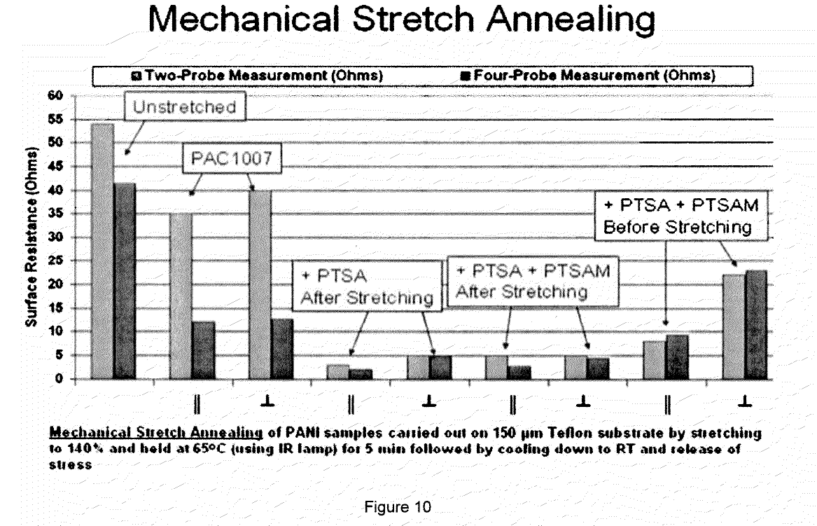

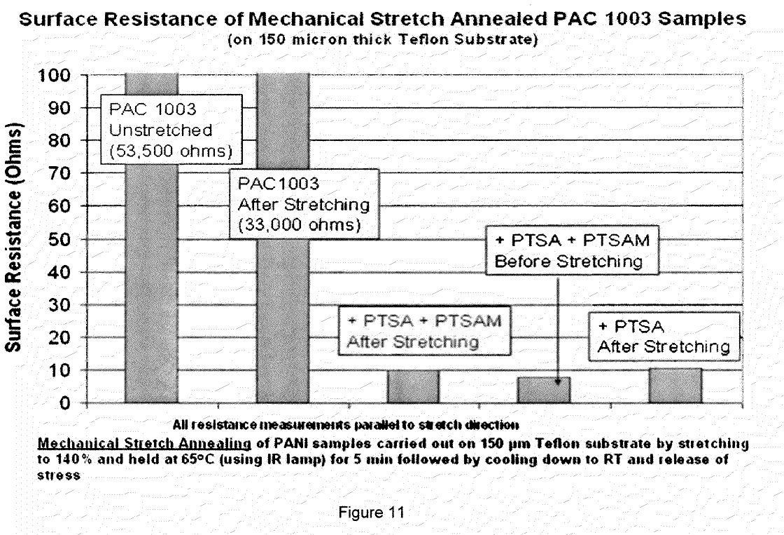

The four-probe resistance of mechanically annealed+chemically annealed PAC™ 1007 films showed a resistance of 2.5 ohms. The unstretched PAC™ 1007 films showed a resistance of 42 ohms. Both parallel and perpendicular resistances are shown in FIG. 10. In particular, it is noted that PAC™ 1007 film on PTFE stretched to 140% followed by chemically annealing with 1:1 v/v 5% PTSA+0.5% TSAm showed a very high conductivity (Table 8). Similar trends in four-probe resistance data for stretched PAC™ 1003 films are set forth in FIG. 11.

TABLE 8
Four-probe electrical conductivity of PAC ™
1007 films mechanically and chemically annealed.

| | Film | Sheet | |
|---|---|---|---|
| PAC ™ 1007 film on | thickness | resistance | Conductivity |
| PTFE | (μm) | (Ohm/Sq.) | (S/cm) |
| Stretched 140% and | 0.44 | 2.5 | 2272 |
| tertiary doped with 1:1 | | | |
| v/v | | | |
| (5% PTSA:0.5% TSAm) | | | |

### Example 8

PANI films were incorporated into a Type I semiconductor coin cell as seen in FIG. 1 using a coin-cell crimping instrument sealed air-tight with a rubber gasket. An Arbin Charge-discharge tester was used to obtain Specific Capacitance, Energy density and power density data and Chronopotentiometry to assess cycling lifetime. Conducting Polymer electrode conductivity was an important design factor that was systematically varied to study the effect on device performance. The ICP film conductivity was varied by varying the film thickness and/or utilizing an ionic liquid or mixture of ionic liquids as an electrolyte.

PANI electrode films (PAC™ 1003) of three different conductivities (PAC™ 1003 of 0.1 S/cm, secondary-doped PAC™ 1003 of 250 S/cm, and secondary-doped PAC™ 1003 of 1000 S/cm) were prepared on various substrates including SS disks to the desired film thicknesses and morphology. Secondary-doped PAC™ 1003 PANI electrodes exhibiting 1000 S/cm conductivity will be hereinafter referred to as “Metallic PANI”. In another variant, a gold interfacial layer (IFL) was deposited on to SS disks before coating PANI films, which improved the conductivity to 4000 S/cm. The electrolyte used was EMI-IM [1-ethyl-3-methylimidazolium bis(trifluoromethanesulfonyl)imide] (Ionic liquid electrolyte) and GORE PTFE (Thickness: 0.0006″) was used as the separator material. The resultant device weight was found to be about 4-5 g. The number of spacers was 2-4 with a stack height of 0.085-0.11″.

The coin cell supercapacitors utilizing conducting polymer electrodes were characterized for specific capacitance by charge discharge and cyclic voltammetric scans. Cycling stability was characterized by chronopotentiometry using a Gamry potentiostat instrument.

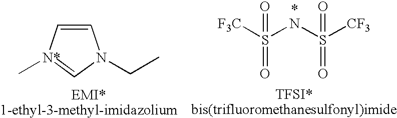

### Chemical Structure of Ionic Electrolyte, EMI-IM

### A) Role of Conducting Polymer Film Conductivity on Device Performance

I. Coin-Cells with Secondary-Doped PAC™ 1003 Electrodes Exhibiting 250 S/cm Conductivity:

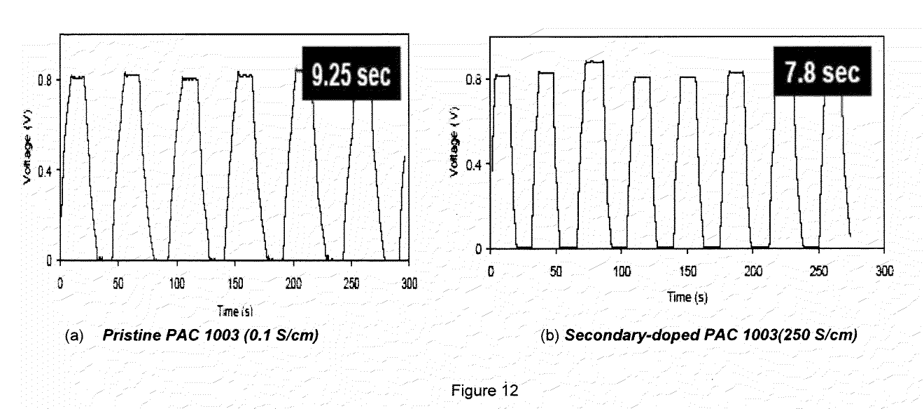

Charge-discharge cycling experiments indicate that the optimal energy and power densities for coin cells utilizing secondary-doped PAC 1003 exhibiting 250 S/cm conductivity as the electrode material (FIG. 11) are 1.92 Wh/Kg and 42.72 W/Kg. More specifically, the charge-discharge cycling experiment was performed by applying 1 mA for 10 sec (charges to 0.8V) and −1 mA for 10 sec (discharges to 0 V). The discharging time of the cell was 7.8 sec. The cycling experiments were conducted up to 500 cycles and electrochemical stability was observed throughout. The charge discharge cycling results may be seen in FIG. 12.

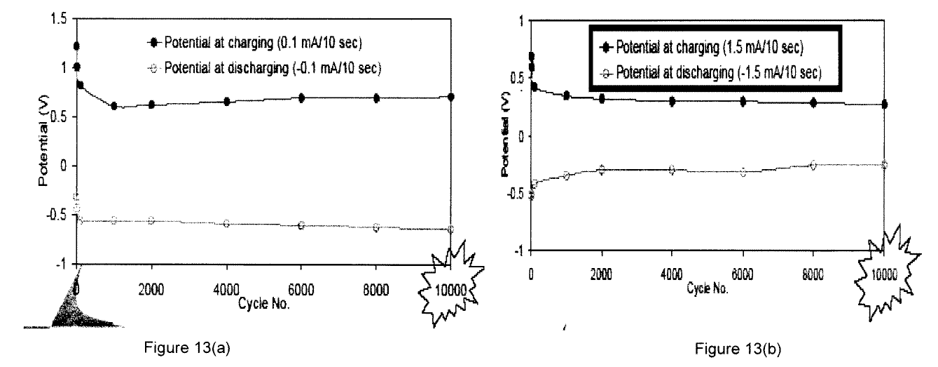

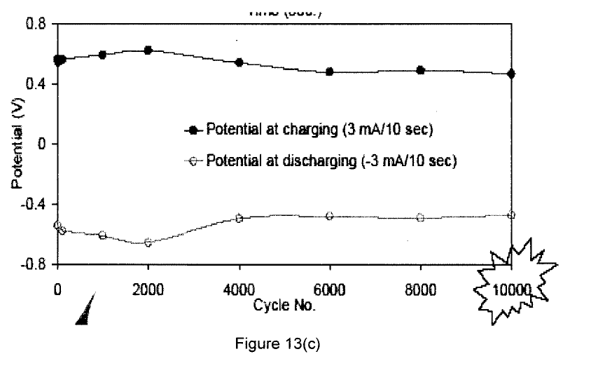

Charge-discharge cycling studies were conducted using chronopotentiometry for PAC™ 1003-based coin cells up to 30,000 cycles in EMI-IM electrolytic media. A stable electrochemical potential window was observed (top line indicates charged state and bottom line indicates discharged state in FIG. 13) up to 10,000 cycles, except for the initial drop in potential for all the PAC™ 1003 based electrodes. However, the overall drop in potential seemed to be significant (to about 50% of the starting potential) for 250 S/cm secondary-doped PAC™ 1003 electrode considering the fact it was subjected to a higher amount of current load (1.5 mA/−1.5 mA-first 10,000 cycles, 3.0 mA/−3.0 mA-second 10,000 cycles, 3.0 mA/−3.0 mA third 10,000 cycles) (see FIG. 13b, 13c, 13d).

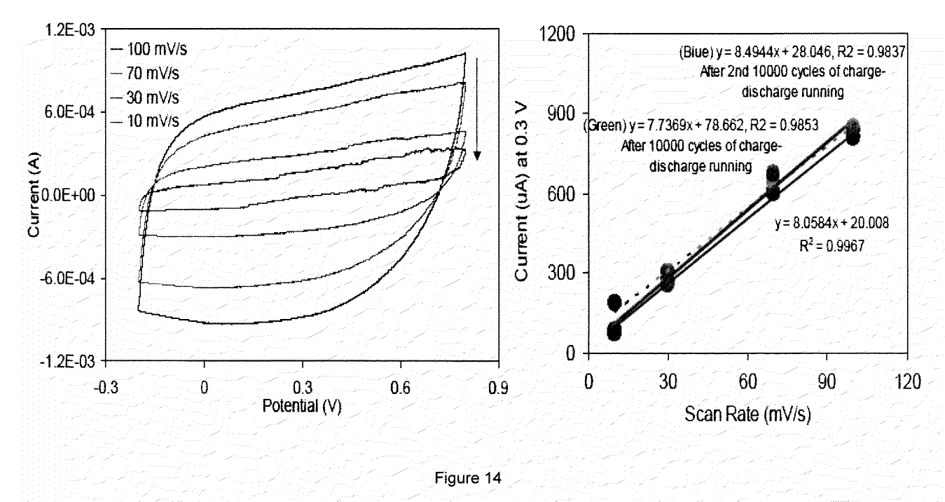

As seen in FIG. 14, the specific capacitance of the coin cell utilizing 250 S/cm secondary-doped PAC 1003 electrodes from 10.07 F/g to 9.67 F/g with cycling up to 10,000 cycles. However, in the case of coin cells utilizing pristine PAC 1003, the specific capacitance decreased from 0.09 F/g to 0.04 F/g with cycling.

### II. Coin Cells Utilizing Metallic PANI (1000 S/cm) Electrodes:

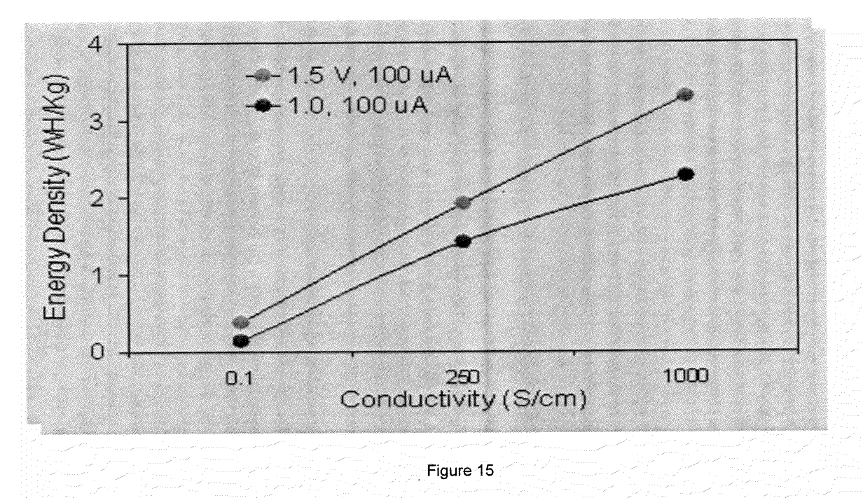

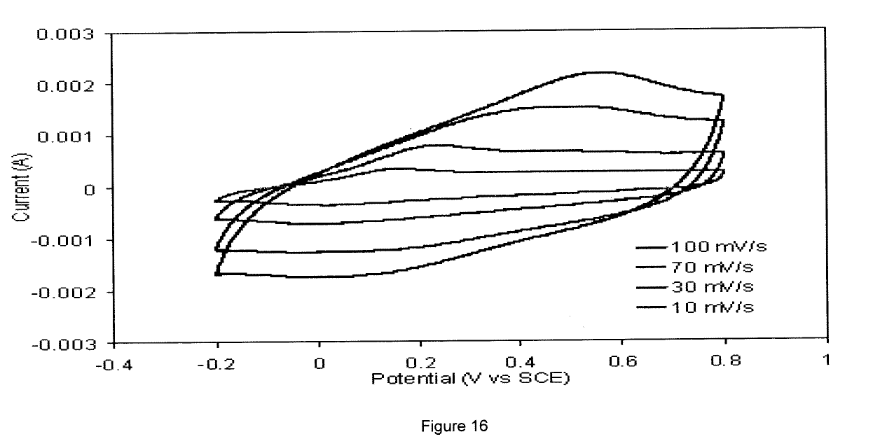

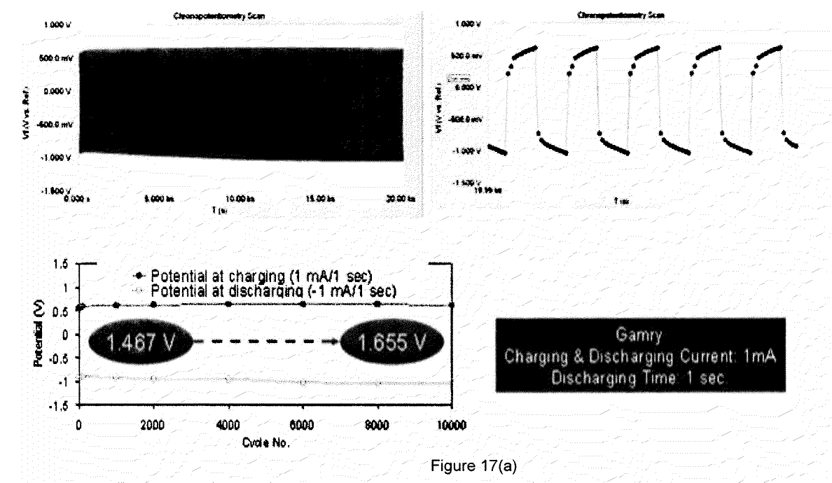

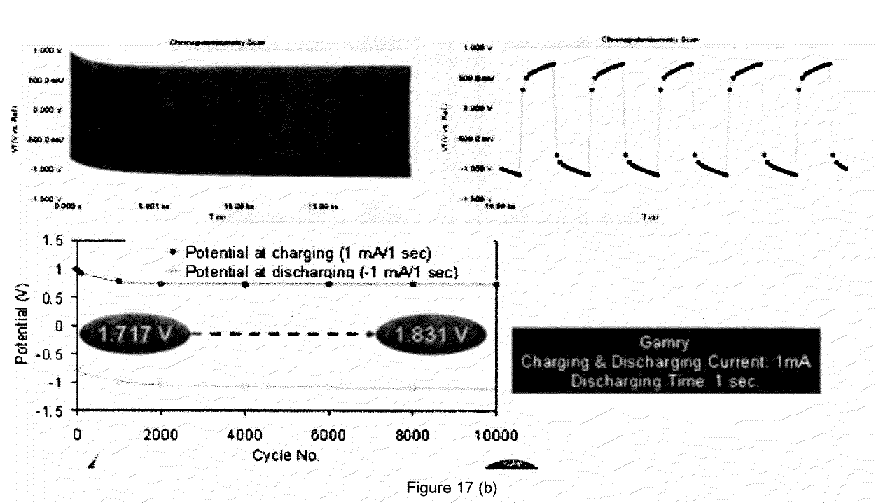

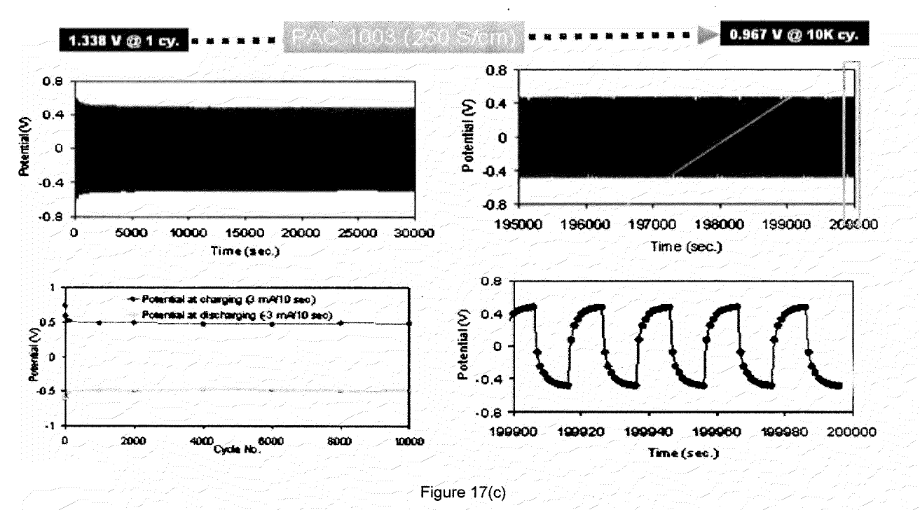

The general trend observed was an enhanced device performance (by several factors) with improvement in PANI film electrical conductivity (as seen in Table 9 and FIG. 15). The specific capacitance, energy and power densities as set forth in Table 10 and plot of FIG. 15, and, in addition, cycling stability is seen in FIG. 16 of coin cells containing metallic PANI film, and this device was found to range from 11.0 to 20.0 F/g of specific capacitance depending on the experimental conditions employed and a stable voltage window at least up to 30,000 charge-discharge cycles (see Table 11 and FIG. 17) for charge-discharge current cycling of ±1 mA was observed.

TABLE 9
Coin Cell Charge-discharge cycling data: Effect of enhancement in electrical
conductivity of PANI on Device performance of Coin cells utilizing metallic
PANI films as electrode material in EMI-IM Ionic Liquid electrolyte.

| | Gold | Electrical | Specific | Energy | Power |
|---|---|---|---|---|---|
| PAC ™ 1003 | Interfacial | Conductivity | Capacitance | Density | Density |
| (PANI) Film | Layer (IFL) | (S/cm)¹ | (F/g)² | (WH/Kg)³ | (W/Kg)³ |
| — | — | 0.1 | 1.2 | 0.38 | 21.67 |
| Secondary | — | 250 | 6.13 | 1.92 | 42.72 |
| Doping - | | | | | |
| Method 1 | | | | | |
| Secondary | — | 1000 | 12.48 | 3.39 | 85.5 |
| Doping - | 10 nm | 4000 | 17.21 | 5.38 | 129.7 |
| Method 2 | | | | | |

¹Measured on glass substrate
²calculated from ED
³Charge-discharge conditions: ±100 μA; limit to 1.5 V, 10 sec hold time between +/− cycles and calculated based on polymer mass; PANI mass in coin cell 0.5-1.9 mg

TABLE 10
Summary of charge-discharge cycling stability data obtained
for coin cells containing metallic PANI films

| Charge- | Charging/ | Charging/ | Potential (V) | Potential (V) |
|---|---|---|---|---|
| Discharge | Discharging | Discharging | at the 1^{st} | at the last |
| cycles | current (mA) | time (sec) | cycle | cycle |
| 1^{st} 10K | 1 | 1 | 1.47 | 1.66 |
| 2^{nd} 10K | | | 1.64 | 1.75 |
| 3^{rd} 10K | | | 1.72 | 1.83 |

### III. Effect of the Presence of Gold Interfacial Layer (IFL) Between Polyaniline Layer and SS Disk on Coin Cell Device Performance

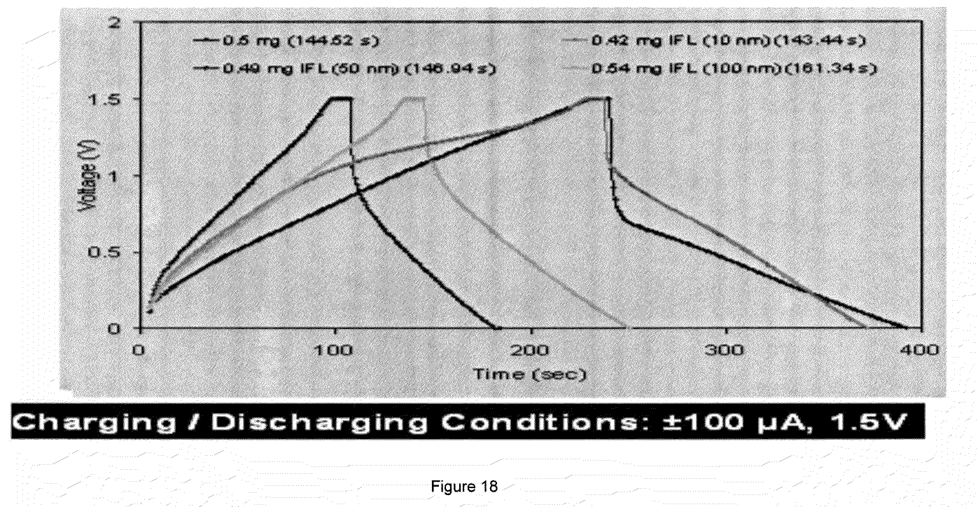

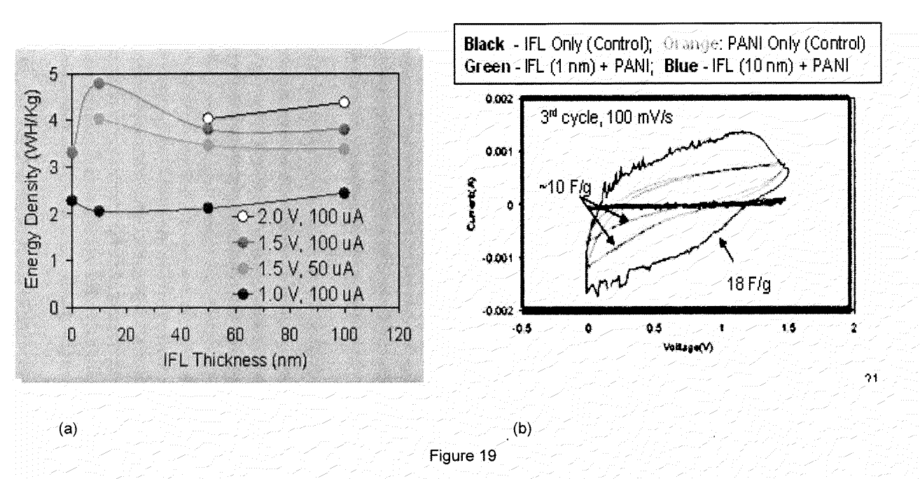

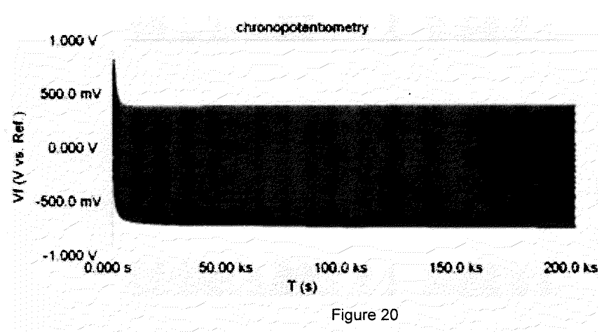

The application of a gold interfacial layer (IFL) between the SS disk and the conducting polymer electrode helps by significantly reducing the undesirable, but significant, IR/ohmic drop (FIG. 18) that is usually observed at the outset of every discharge in the electrode without an IFL. The presence of an interfacial layer (IFL) (see FIG. 18) between the PANI coating and the SS disk current collector improves the performance of the coin cell device by widening the potential window of stable device operation and improving the device specific capacitance (FIG. 19, Tables 11 and 12). The thickness of gold IFL was varied between 10 nm and 100 nm and it was found that increasing the thickness beyond 10 nm did not have any significant impact on the device performance (FIG. 19). The cycling stability of this device is at least up to 30,000 cycles (see FIG. 20).

TABLE 11
Charge-discharge cycling results of coin cells utilizing electrodes
with metallic PANI containing gold interfacial layer in EMI-IM
electrolytic media.

| | | | | | Energy | |
|---|---|---|---|---|---|---|
| Interfacial | PANI | | | | Density | Power |
| Layer | mass | | Voltage | Current | (WH/ | Density |
| (IFL) | (mg)² | Electrolytes | (V) | (μA) | Kg)² | (W/Kg)² |
| — | 1.54 | EMI-IM | 1.5 | 100 | 1.31 | 22.32 |
| 1 nm | 1.27 | | | | 1.88 | 33.29 |
| 10 nm | 1.22 | | | | 2.80 | 42.49 |

¹polymer mass on both electrodes
²calculated based on polymer mass

TABLE 12
Charge-discharge cycling results of coin cells utilizing electrodes
with metallic PANI films containing interfacial layer in EMI-IM
Ionic Liquid electrolyte

| | | Polymer | | | D | |
|---|---|---|---|---|---|---|
| Interfacial | | mass | Voltage | Current | (WH/ | D |
| Layer | Electrolyte | (mg)¹ | (V) | (μA) | Kg)² | (W/Kg)² |
| — | EMI-IM | 0.5 | 1.5 | 100 | 3.3 | 82.2 |
| 10 nm | | 0.42 | | | 4.79 | 120.1 |
| 50 nm | | 0.49 | | | 3.80 | 93.0 |
| 100 nm | | 0.54 | | | 3.78 | 4.29 |

| | Charge/ | Potential | Potential |
|---|---|---|---|
| Charge- | Discharge | (V) at | (V) at |
| Discharge | Current | the 1st | the last |
| Cycles | (μA) | Cycle | Cycle |
| 30,000 | 500 | 1.00 | 1.12 |

¹polymer mass on both electrodes
²calculated based on polymer mass

### B) Effect of Conducting Polymer Mass (or Thickness) on Device Performance

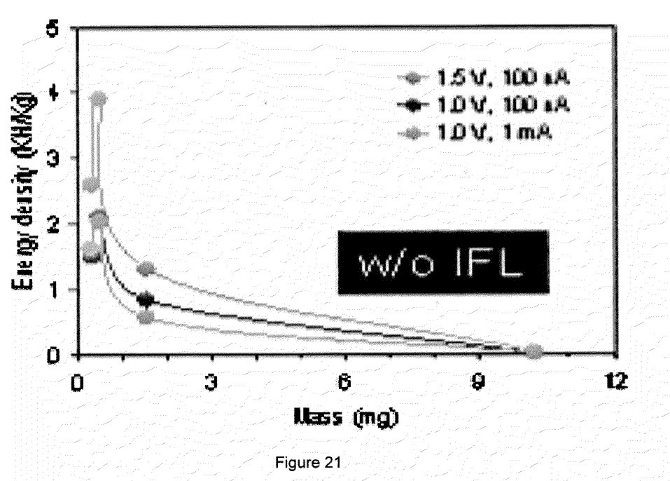

Charge-discharge cycling was conducted on a set of coin cells each containing varying mass of metallic PANI films coated on SS disk without the presence of any IFL. Coin cells with lower mass (0.31 mg) of PANI displayed higher energy density (FIG. 21) and faster discharging characteristics than the device with relatively higher polymer mass (1.54 mg PANI).

### C) Effect of Ionic Liquid-Based Electrolytic Composition on Device Performance

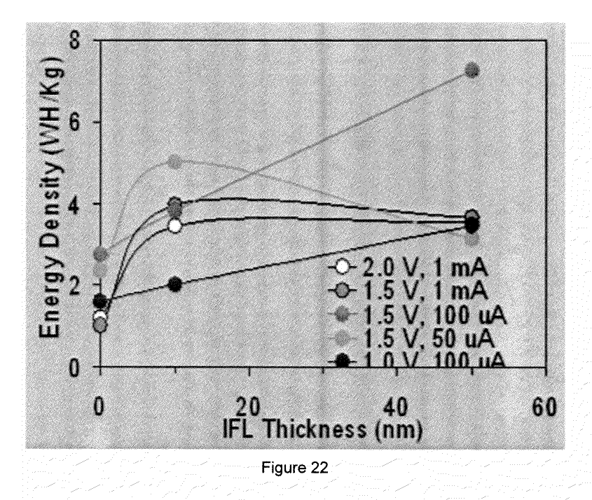

Most of the coin cell studies involved the use of ionic liquid EMI-IM [1-ethyl-3-methylimidazolium bis(trifluoromethanesulfonyl)imide] as the electrolyte. The effect of mixture of ionic liquid that has a second ionic liquid component, such as lithium bis(trifluoromethanesulfonyl)imide (Li-IM) on coin cell device performance was also investigated. A jump in energy density by at least a factor of two was observed by including Li-Im as a component in the electrolytic composition (see Table 13 and FIG. 22) compared to the data obtained for pristine EMI-Im (i.e. without Li-Im present) shown earlier.

TABLE 13
Effect of introducing Li-IM as second ionic liquid electrolytic
component in EMI-IM electrolyte on device performance for coin cells
utilizing electrodes with metallic PANI containing gold interfacial layer.

| | | Polymer | | | | | | Specific |
|---|---|---|---|---|---|---|---|---|
| | | Mass | Voltage | Current | ED | PD | PD | Capacitance |
| IFL¹ | Electrolytes | (mg)² | (V) | (A) | (WH/Kg)³ | (W/Kg)³ | (W/Kg⁴ | (F/g)⁵ |
| — | EMI-Im/ | 0.92 | 1.5 | 0.001 | 1.01 | 177 | 1630.43 | 10.32 |
| Au | Li-IM | 0.77 | | | 3.95 | 494.7 | 1948.05 | 13.81 |
| 10 nm | (75/25 w/w | | | | | | | |
| Au | %) | 0.55 | | | 3.65 | 527.3 | 2727.27 | 20.73 |
| 50 nm | | | | | | | | |
| — | | 0.92 | | 0.0001 | 2.74 | 485 | 163.04 | 10.32 |
| Au | | 0.77 | | | 3.82 | 65.35 | 194.81 | 13.81 |
| 10 nm | | | | | | | | |
| Au | | 0.55 | | | 7.25 | 106.2 | 272.73 | 20.73 |
| 50 nm | | | | | | | | |

¹PAC ™ 1003 (1000 rpm, 30 sec)/Thymol vapor/PTSA-TSAm coated on the interfacial layer
²polymer mass on the two electrodes
^{3,4}calculated based on polymer mass/EDmax: calculated from applied power.
⁵calculated based on polymer mass & CV.

### Example 9

In this example, supercapacitors were formulated using doped films of the present invention and carbon formulations as electrodes. Several formulations were made in different ratios.

PAC™ 1003 (45% solids) was transferred into a 50 mL beaker. An equal volume amount of methanol was added and stirred for five minutes. PAC™ 1003 is not soluble in methanol and only excess DNNSA is extracted. This allows polyaniline doped with DNNSA to settle down and be filtered. A vacuum filtration apparatus was set up. The solid, doped PAC™ 1003 settled and was filtered and washed with methanol. It was allowed to dry at room temperature then at 150° C. for 30 minutes. The powder was then pulverized in a mortar.

Using this PAC™ 1003 powder, a formulation containing 75% PAC™ 1003 powder, 20% activated carbon and 5% carbon black, by weight, was formulated. Other formulations, such as 45% PAC™ 1003, 50% activated carbon and 5% carbon black were also formulated. The use of PAC™ 1003 45% solid formulation instead of the powder form was also investigated. This entailed using the wet weight of PAC™ 1003 instead and then drying the final composition.

PANI DBSA (JJH2140) was already in powder form. Its formulations with activated carbon and carbon black were similar to that of PAC™ 1003 in terms of composition ratios.

To fabricate the pellets, a weighed sample was placed in the pellet die disk pressure device from SamplePrep and pressure was applied. Different pressures were first studied to establish the optimal setting and then applied to the other pellets.

### Coin Cell Fabrication and Characterization

Separator=23 μm thick Gore separator
   Electrolyte=EMI-IM

The pellets (13 mm) were placed on the stainless steel disks and crimped at 300 psi. Using the Arbin Battery Tester, the coin cells were analyzed at different charging and discharging conditions (0.1 mA, 1 mA, 10 mA, 100 mA, and 1-3V) and scanning rates.

During charge and discharge cycles, the effects of including a hold time were investigated. This was done by setting the equipment to hold potential at 0 s, 2 s and 10 s at maximum and minimum values. This was necessitated by the revelation that the hold time might be giving erroneous results.

### Electrochemical ‘Activation’ of Coin Cells

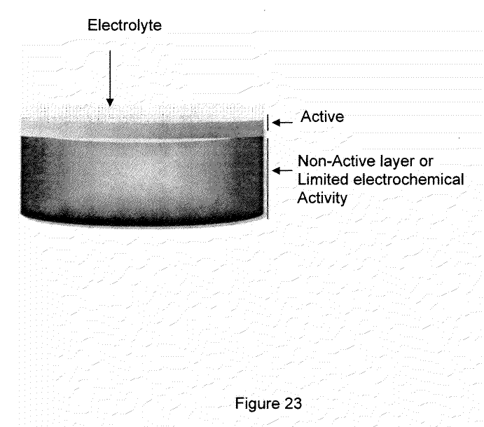

Coin cells fabricated utilizing thick films or pellets showed reduced Energy densities (WH/Kg of active material) as the active material amount was increased (FIG. 23). This is believed to be caused by poor electron pathways in the thick films and inability of the electrolyte to efficiently ‘communicate’ with the entire active material. This renders most of the electrode material inactive. To activate, the coin cells were first charged at slow charging rate to create electronic pathways through the material. High currents were also used to establish the pathways.

### PANI/DBSA C-Fiber

This formulation exhibited better charge-discharge capabilities. At low current (<1 mA) though, PANI/DBSA/c-fiber coin cells could not charge to maximum 1.0 V. It would likely take up to several days to reach a charge of 1 V. There was no significant difference between the 3:1 and 2:1 ratios of PANI DBSA to carbon fiber.

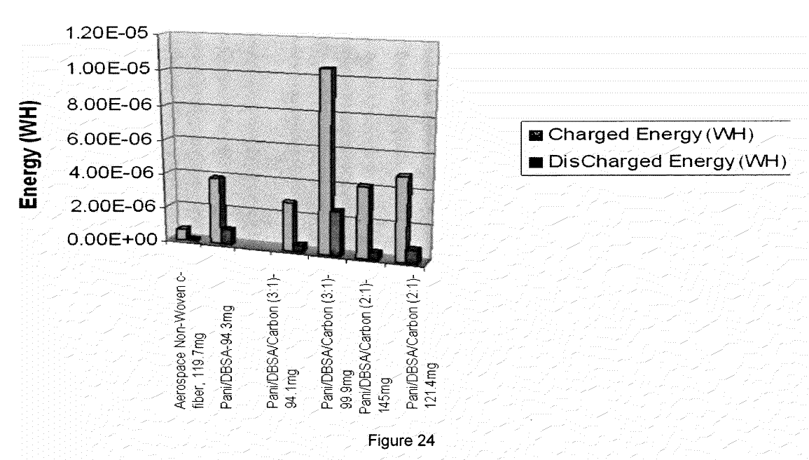

It was also clear that the charged energy per coin cell was remarkably high compared to discharged energy. At higher voltage, these devices could discharge more energy than lower current. (FIG. 24)

TABLE 14
Different Formulations of PANI and Carbon fiber (3:1 and 2:1)
Device PANI/DBSA:Carbon fiber (2:1)

| | | | Active |
|---|---|---|---|
| Operating Conditions | Energy(J) | (J/s) | material wt |
| 100 mA, 1.0 V | 0.008 | 0.00080 | 0.1450 g |
| 1 mA, 1.5 V | 0.004 | 0.00010 | |
| 100 mA, 1.0 V | 0.01 | 0.00100 | 0.1214 |
| 1 mA, 1.5 V | 0.007 | 0.00013 | |

Effects of Hold time on Charged and Discharged Energy

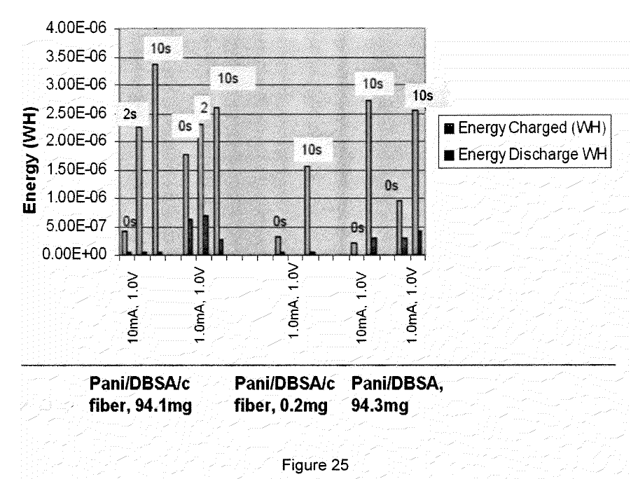

From the energy calculation equation shown above, charged and discharged time is a big factor in the calculation. PANI/DBSA/C-fiber coin cell were characterized for charge discharge at 0 s, 2 s and 10 s hold time. The results were as seen in FIG. 25.

$$Energy density ( ED , Wh \text{/} Kg ) = \frac{1 \times V \times Td}{2 \times m \times 3600}$$

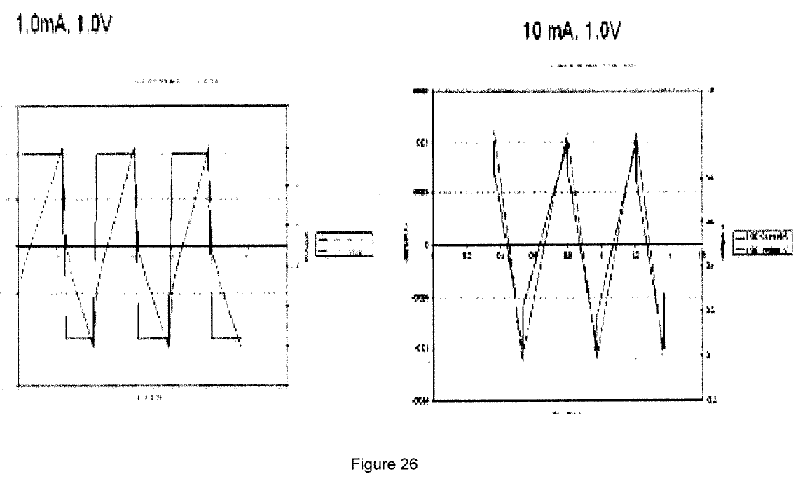

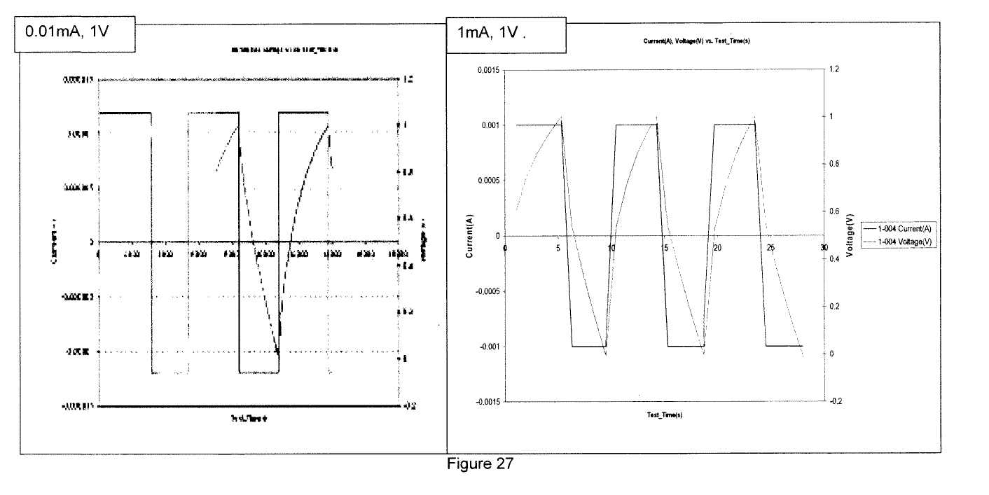

From the charge-discharge cycles shown in FIGS. 26 and 27, it may be seen that at low current, the particular devices unexpectedly showed higher IR drop. At higher currents, the current cannot keep up with potential change. The energy accumulated, however, was minimal.

### PAC™ 1003: Activated Powder: Carbon Black Pellets

PAC™ 1003 pellets were prepared by pressing a known amount of PAC™ 1003 powder to form pellets. The pellets were incorporated into a coin cell. PAC™ 1003 pellet coin cells were observed to charge very quickly but accumulated very little energy at 10 mA or greater. However, the energy accumulated by these pellets was a significant improvement from the film-based coin cells utilizing PAC™ 1003. The coin cells showed higher efficiency at low current but the power was very low (0.001J/Device discharged energy and 1.7 W/Kg of active material).

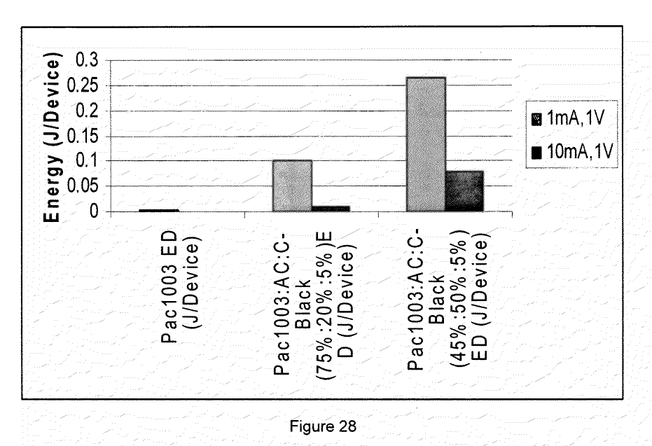

To improve energy and power, activated carbon was chosen to assist with energy density while carbon black was chosen to improve the electronic conductivity. Different formulations tried and reported here are 75%:20%:5%, 45%:50%:5% of PAC™ 1003: activated carbon: carbon black respectively. The pellets were pressed at 2000 psi and EMI-IM was the electrolyte. The charge-discharge curves are shown in FIG. 28.

TABLE 15
Energy and Power results for PAC ™ 1003 and its Activated
carbon formulations

| | | | PAC ™ | | PAC ™ | |
|---|---|---|---|---|---|---|
| | | | 1003:AC:C- | | 1003:AC:C- | |
| | PAC ™ | | Black | | Black | |
| | 1003 | | (75%:20%:5%) | | (45%:50%:5%) | |
| | ED | PD (W/Kg | ED | PD (W/Kg | ED | PD (W/Kg |
| | (J/ | active | (J/ | active | (J/ | active |
| | Device) | material | Device) | material | Device) | material |
| 1 mA, | 0.002 | 2.04 | 0.1 | 2.58 | 0.264 | 2.7 |
| 1 V | | | | | | |
| 10 mA, | | | 0.01 | 16.6 | 0.08 | 18.7 |
| 1 V | | | | | | |

As seen in FIG. 29, formulating PAC™ 1003 powder with activated carbon and carbon black showed enhanced energy and power densities. Addition of carbon powder and carbon black improved the energy density but significantly increased the charging time. At lower, charging and discharging current, energy density was very high. This is typical for supercapacitors.

This example shows there is an advantage to including activated carbon in the pellets, moving from 20% activated carbon to 50%, energy increases but the power remains steady. This is an indication that the material property in terms of energy capacity is improved with no significant damage in electronic conduction properties.

TABLE 16
Results of PAC ™ 1003/Carbon formulations
PAC ™ 1003 powder/Activated carbon/c-Black (75%:20%:5%)

| | Sample 3B | | Sample 3C | | Sample 6 | |
|---|---|---|---|---|---|---|
| | | Discharging Rate | | Discharging | | Discharging Rate |
| | J/Device | (J/s) | J/Device | Rate (J/s) | J/Device | (J/s) |
| 1 mA/1 V | 0.15 | 0.0004 | 0.11 | 0.0004 | 0.1 | 0.0004 |
| 10 mA/1 V | 0.0034 | 0.002 | 0.01 | 0.003 | 0.01 | 0.013 |

| | ED | | ED | | ED | |
|---|---|---|---|---|---|---|
| | (WH/Kg) | PD (W/Kg) | (WH/Kg) | PD (W/Kg) | (WH/Kg) | PD (W/Kg) |
| 1 mA/1 V | 0.2 | 1.7 | 0.2 | 2.6 | 0.15 | 2.32 |
| 10 mA/1 V | 0.004 | 9.05 | 0.02 | 16.6 | 0.023 | 16.3 |

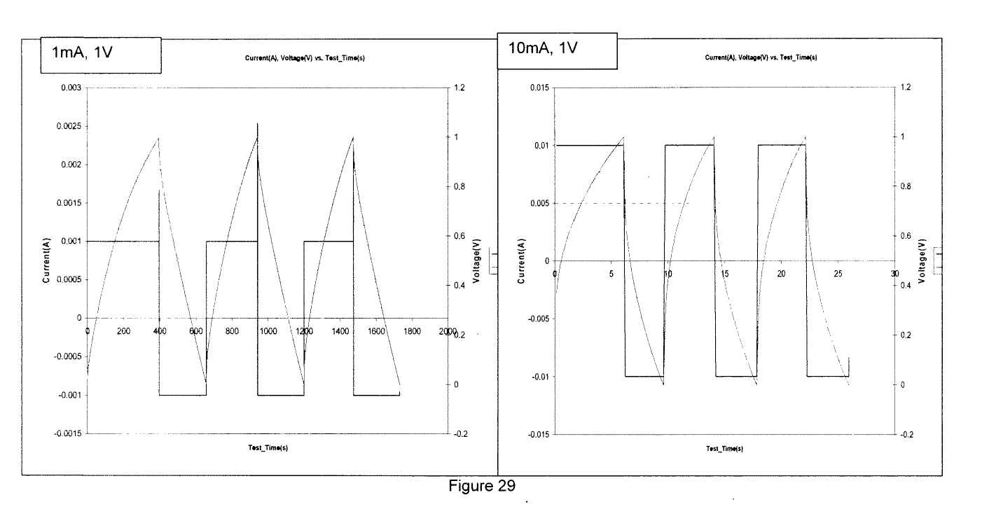

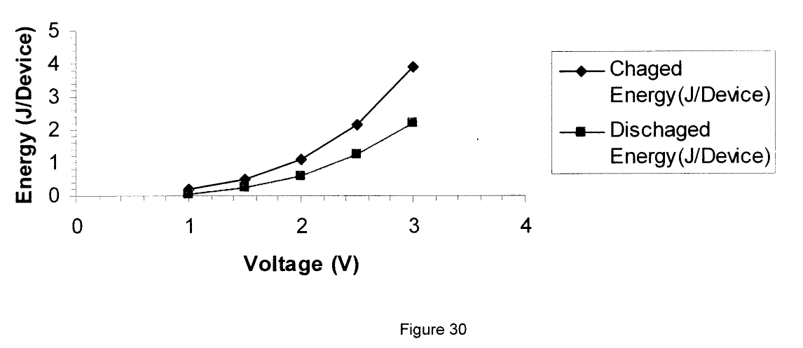

PAC™ 1003/activated carbon and carbon black formulations also exhibited higher charged energy at 10 mA and 1 V, but the discharge energy was low as seen in FIG. 30. This indicates very little ion mobility during discharge. At high current, the IR drop was high. At low current, the IR drop was low, but the power was also low.

### Activated Carbon Control

Typically, pellets of activated carbon are formed by including a small amount of PTFE to assist with adhesion and pellet integrity. With the activated carbon utilized herein, this was not possible. Even pressing the pellets at 4000 psi did not result in pellet retention. Additionally, 5% to 20% w/w of PTFE in activated carbon did not result in pellet formation. When higher concentrations of PTFE binder were utilized to fabricate the pellets, the pellets formed were weak and unable to withstand the rigors of coin cell fabrication. To assist with binding, colloidal graphite was used in place of PTFE. The colloidal graphite from Ted Pella, (Redding, Calif.) was in the form of a high viscosity paste. To prepare the pellets, 0.86 g of activated carbon, 0.06 g of carbon black, and 2.11 g of the colloidal graphite were weighed into a mortar. They were mixed well and dried at 150° C. for 15 min in the oven to remove any isopropanol. The resulting solid was crushed and pulverized before pellets were fabricated. Pellets at 2000 psi were firm and easy to use in coin cells.

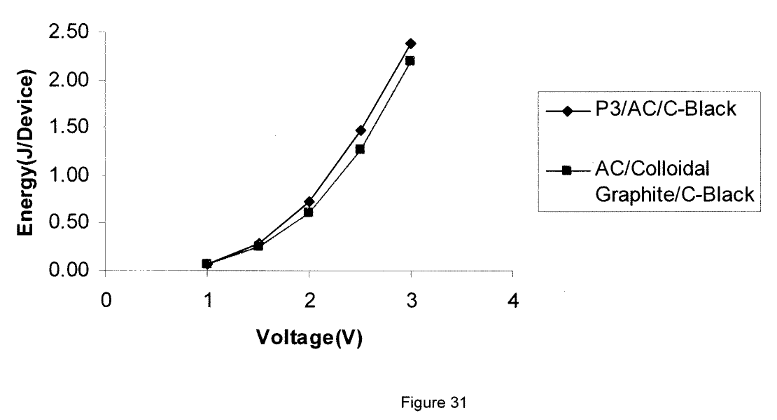

The values obtained indicated a systematic increase in power and Energy as the voltage window was expanded to 3V. The best values were seen in the 2.2 J/device with 0.017 J/s power (FIG. 31).

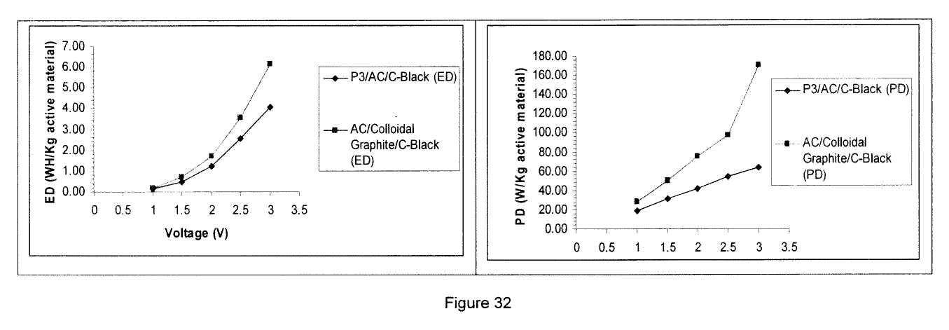

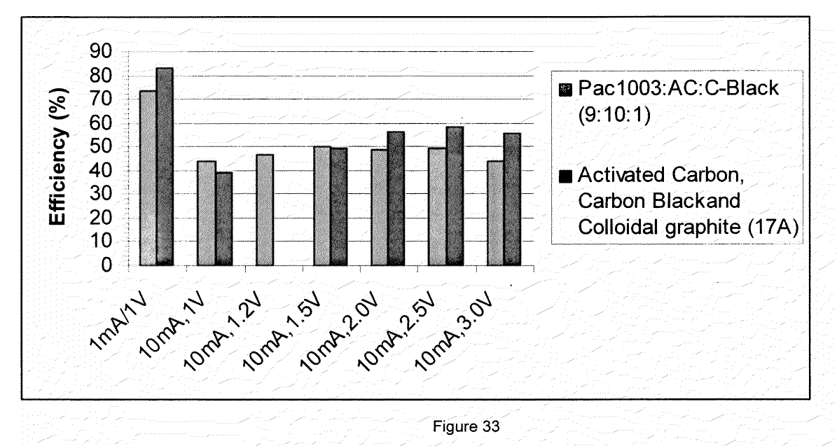

The best PAC™ 1003 and activated composite coin cell (45%:50%:5%) was put through similar conditions as the activated carbon control. Comparing the discharged energy of activated carbon control coin cell and that of PAC™ 1003 composite, the two seemed to follow a similar trend with PAC™ 1003 composite showing slightly improved performance as compared to the carbon. The formulation of PAC™ 1003 composite used here was PAC™ 1003/activated carbon/carbon black (45:50:5). Energy density of the PAC™ 1003 formulation was higher. The power was similar with activated carbon having slightly higher power. The discrepancy of activated carbon having a similar or better power density than the PAC™ 1003 formulation was attributed to the presence of conductive graphite that was used as a binder. Activated carbon, when formulated together with PAC™ 1003 helped stabilize the charge-discharge cycles and expanded the voltage window. After obtaining 100 cycles at 10 mA and 1 V, the PAC™ 1003 formulation only showed increasing charge per cycle while the activated carbon lost charge. These results may be seen in FIGS. 32 and 33. As the voltages increases, PAC™ 1003/activated carbon/carbon black (9:10:1) behaves more like carbon

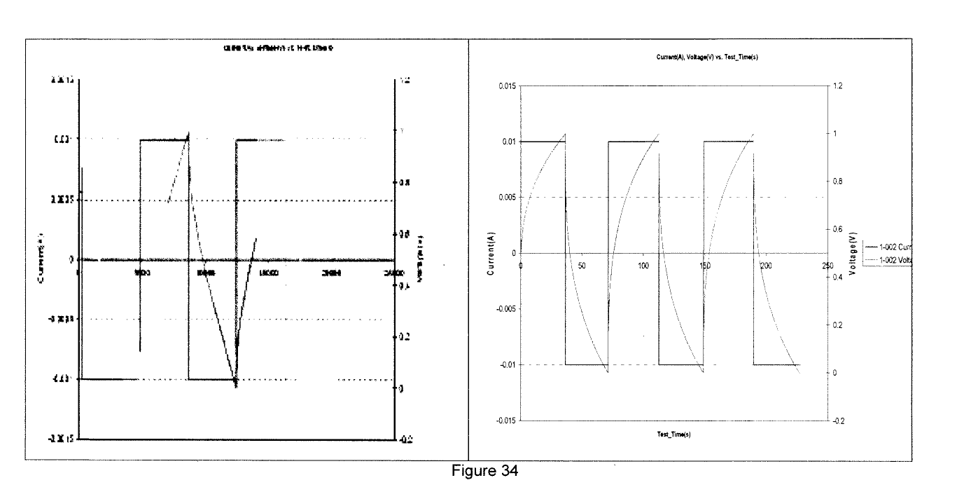

Efficiency, being the percent of the amount of charge actually discharged was calculated [Efficiency=Discharged Energy (J/Device)×100%/Charged Energy (J/Device)]. The two devices exhibited close efficiencies at low and high voltage. PAC™ 1003 composite, at 10 mA, efficiency increased to a maximum at 1.5 V while the carbon held higher efficiency, up to about 3.0 V, as can be seen in FIG. 34.

### PANI/DBSA

Coin cells of PANI/DBSA (JJH2140) were fabricated. The PANI/DBSA was in powder form. The best pressure for forming pellets was observed to be 2000 psi. At higher pressure, the coin cell performance was poor. Formulation of PANI/DBSA with carbon was prepared using the same technique as PAC™ 1003 above, i.e. 75% PANI/DBSA: 20% activated carbon: 5% carbon black and the 45%:50%:5% ratio.

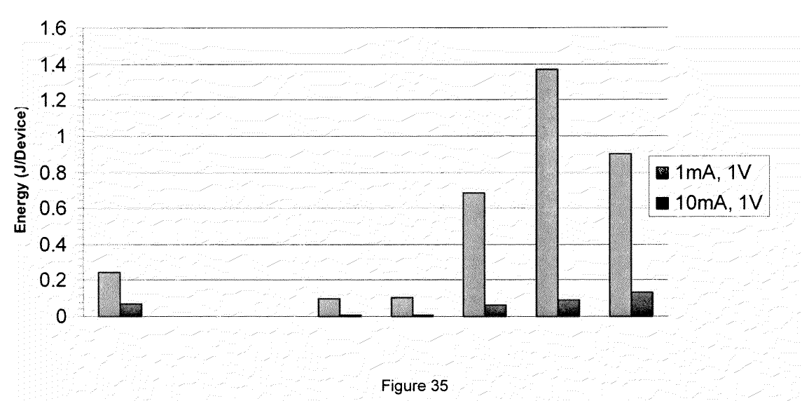

As seen in the PAC™ 1003 formulations, the PANI/DBSA coin cell exhibited higher energy at lower current and higher power density at higher current. At higher current though, the IR drop was large and this worked against the energy out-put of the device. The PANI/DBSA coin cell out-performed the PAC™ 1003 coin cells as can be seen in FIG. 35.

TABLE 17
Results of PANI/DBSA coin cells
PANI/DBSA

| | | Discharging | ED | PD |
|---|---|---|---|---|
| | J/Device | Rate (J/s) | (WH/Kg) | (W/Kg) |
| 1 mA/1 V | 0.69 | 0.0003 | 1.91 | 2.94 |
| 10 mA/1 V | 0.06 | 0.002 | 0.2 | 19.1 |

TABLE 18
Results of PANI/DBSA activated carbon coin cells
PANI/DBSA powder/activated carbon/c-Black (75%:20%:5%)

| | Sample 10A | | Sample 10B | |
|---|---|---|---|---|
| | J/Device | Power (J/s) | J/Device | Power (J/s) |
| 1 mA/1 V | 1.37 | 0.004 | 0.9 | 0.004 |
| 10 mA/1 V | 0.09 | 0.002 | 0.13 | 0.002 |
| | D | PD | ED | PD |
| | (WH/Kg) | (W/Kg) | (WH/Kg) | (W/Kg) |
| 1 mA/1 V | 2.7 | 2.54 | 3 | 5.11 |
| 10 mA/1 V | 0.2 | 16.5 | 0.43 | 30.6 |

TABLE 19
Voltage variation effects on Power and
Energy densities of PANI/DBSA coin cell
PANI/DBSA Activated carbon and Carbon Black (45%:50%:5%)

| Conditions | Energy (J) | Power J/s | Energy WH/Kg | Power W/Kg |
|---|---|---|---|---|
| 1 mA, 1 V | 1.0440 | 0.0004 | 2.63 | 3.96 |
| 10 mA, 1 V | 0.3204 | 0.0031 | 0.81 | 27.93 |
| 10 mA, 1.2 V | 0.6120 | 0.0039 | 1.54 | 35.57 |
| 10 mA, 1.5 V | 1.1160 | 0.0046 | 2.81 | 41.81 |
| 10 mA, 2.0 V | 1.4760 | 0.0046 | 3.72 | 42.08 |
| 10 mA, 2.5 V | 1.4040 | 0.0044 | 3.54 | 39.78 |

In general, PANI/DBSA/activated carbon/carbon black had the best results. At 1 mA and 1V, the device had 1.37 J/device as compared to 0.11 J/Device for Pac1003/Activated Carbon/Carbon Black. From the previous results for thin film-based coin cell, this is a 100 order of improvement.

In terms of J/s, PANI/DBSA and PAC™ 1003 carbon composites had similar values. This is an indication that pristine PAC™ 1003 does not have sufficient energy storage capability compared to DBSA but it can help with energy transfer and as a conductive binder with PANI/binder.

### Electrochemical Activation

Due to low energy and power densities seen in the coin cells, electrochemical activation was attempted by cycling up to 100 cycles and comparing the first and the last cycles. The procedure was expected to show improvement as the charge-discharge cycles increased.

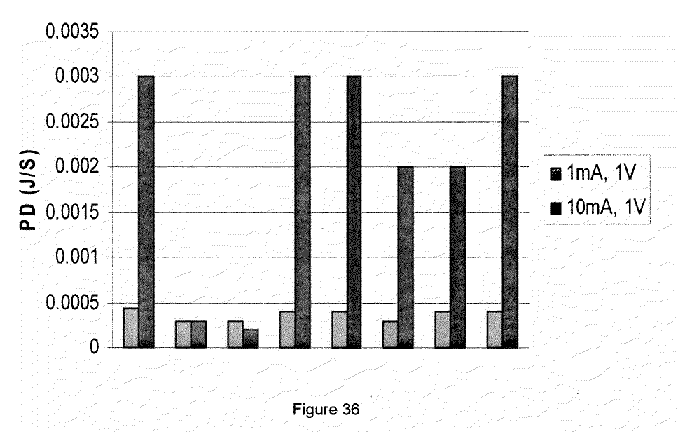

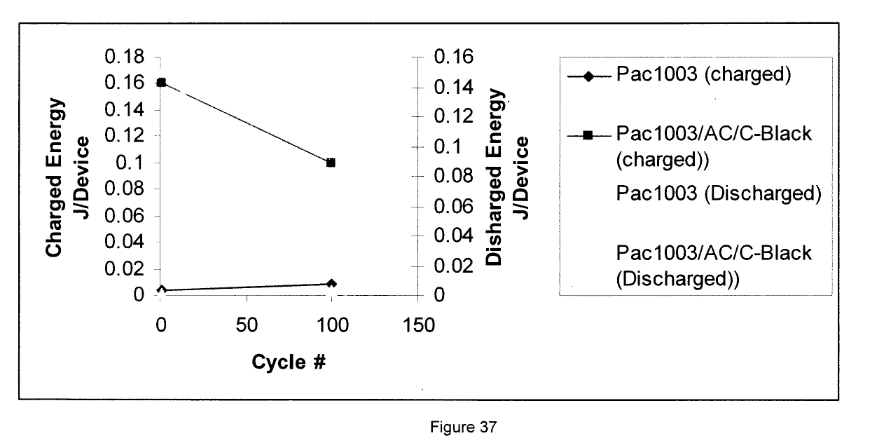

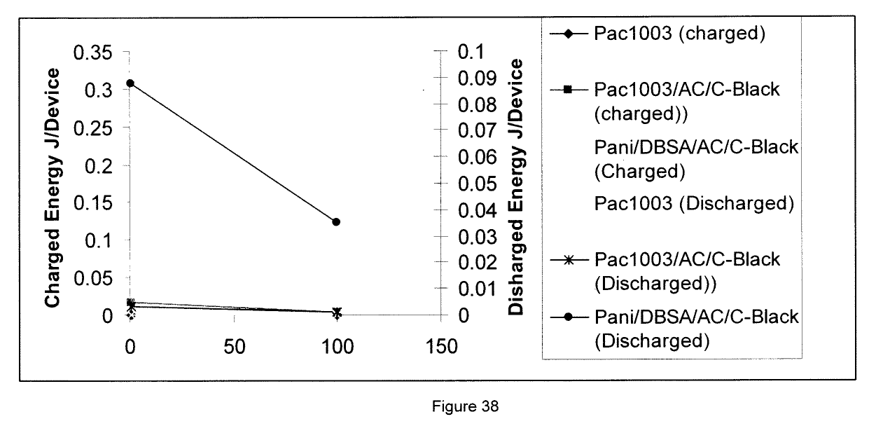

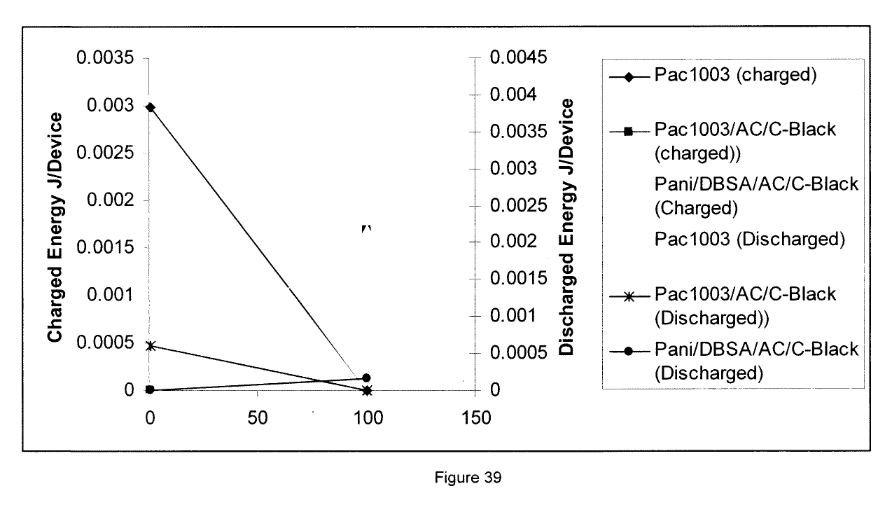

In general, no significant improvement or negative effects were observed for the devices tested as seen in FIGS. 36, 37, 38, and 39

### Voltage Effects on Cycle Stability

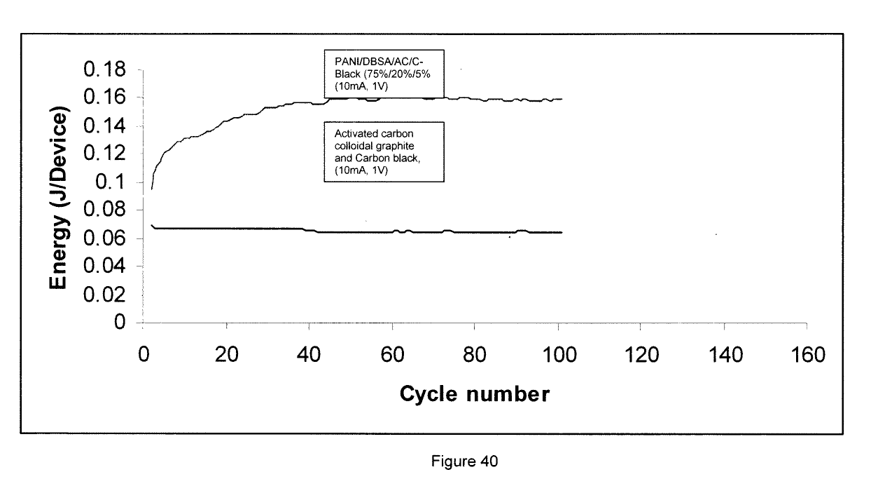

The effects of voltage on cycle stability may be observed in FIG. 40.

### Example 10

To compare the effect of 10 nM Gold interfacial Layer (IFL) on stainless steel disks used to fabricate PAC™ 1003, PANI/DBSA and their carbon formulations, a set of stainless steel disks was coated with 10 nm gold and used to fabricate pellet-based coin cells. The data reported is for 10 mA and 1 mA at 1 V.

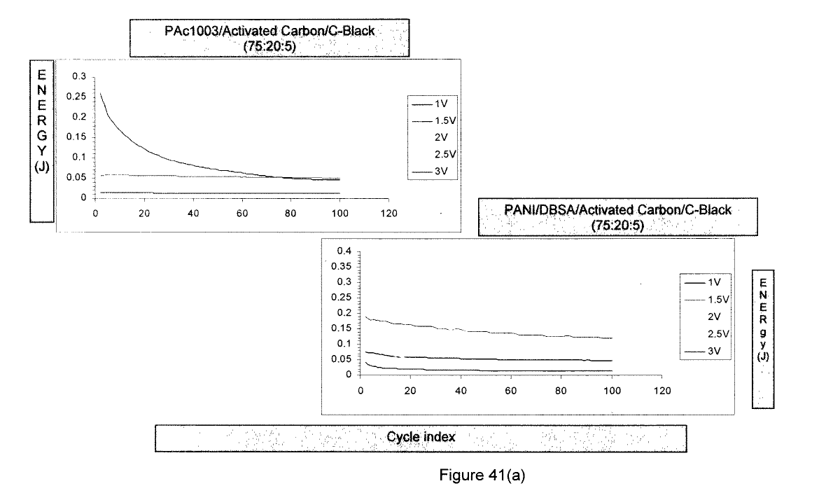

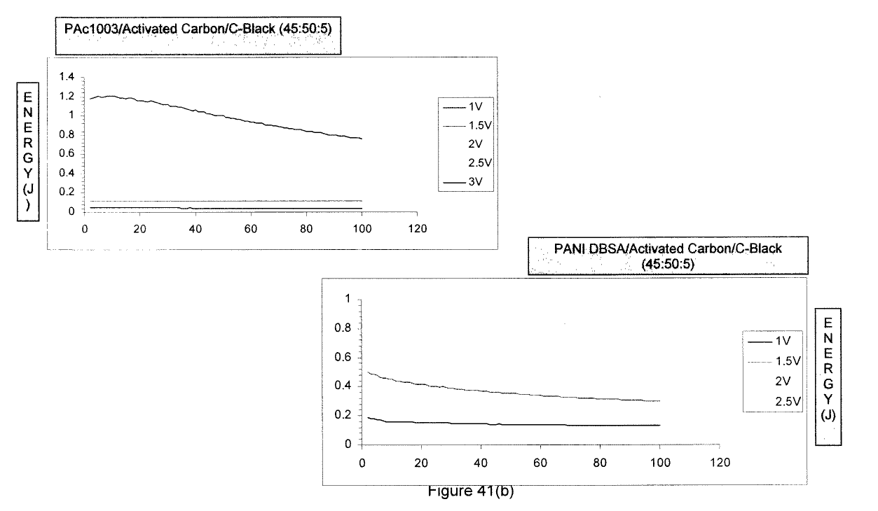

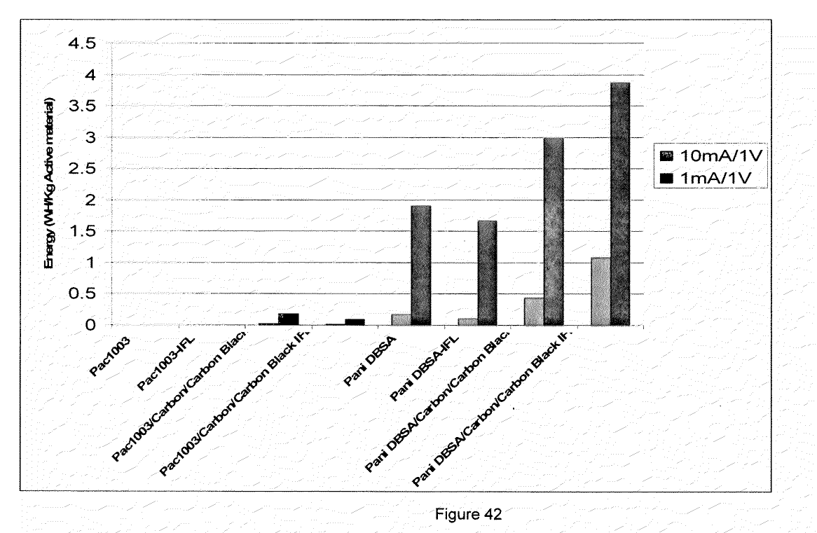

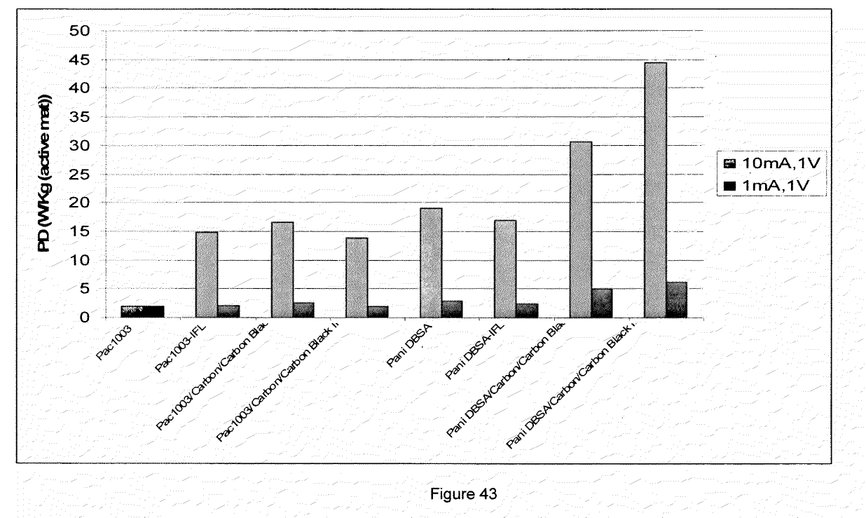

For each of FIGS. 41-43, the order is as shown below;

### 1 PAC™ 1003

2 PAC™ 1003 with IFL SS disks

### 3 PAC™ 1003/Carbon/Carbon Black

4 PAC™ 1003/Carbon/Carbon Black with IFL SS disks

### 5 PANI DBSA

6 PANI DBSA-with IFL SS disks

### 7 PANI DBSA/Carbon/Carbon Black

8 PANI DBSA/Carbon/Carbon Black with IFL SS disks

PANI/DBSA/activated carbon/carbon black and PAC™ 1003/activated carbon/carbon black formulations were formulated at a ratio of 75%:20%:5% w/w. No remarkable difference or advantage was observed by using gold interfacial layer. Significant effects could however, be observed at higher voltages.

### Example 11

In this example, coin cells were formulated with pelletized electrodes and paste-based electrodes of PAC™ 1003 or PANI/DBSA.

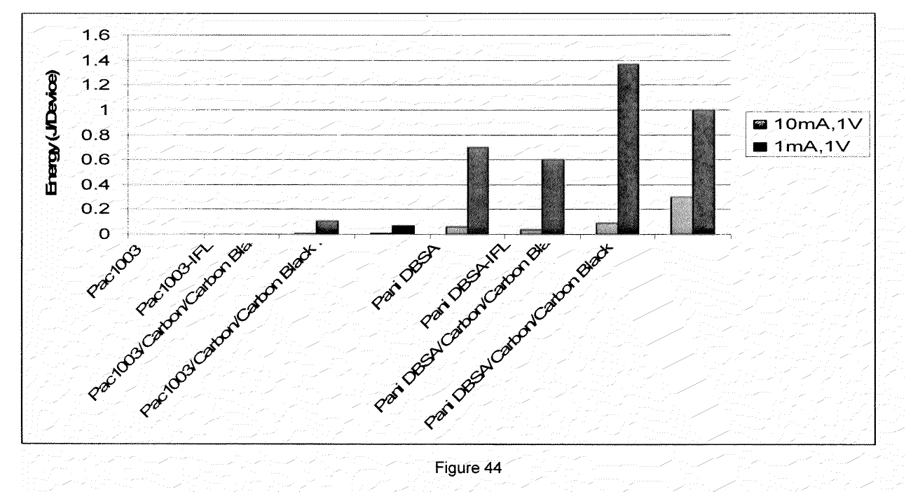

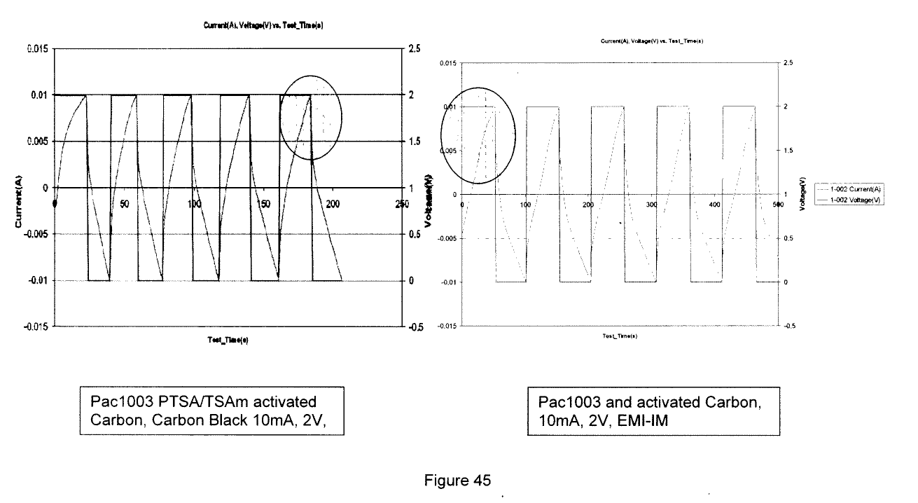

To increase capacity and reduce IR drop, PAC™ 1003 was doped with PTSA/TSAm as set forth above. Specific capacitance of this material increased and there was evidence of IR drop for PAC™ 1003 PTSA/TSAm pellet coin cells as seen in FIGS. 44 and 45.

TABLE 20
Effects of PTSA/TSAm on Energy (WH/Kg)

| PAC ™ 1003 | | | PAC ™ 1003/PTSA/TSAm/activated |
|---|---|---|---|
| Pellets (0.5″ dia, | | PAC ™ | Carbon and Carbon Black |
| 1 mm thickness) | PAC ™ 1003 | 1003/PTSA/TSAm | (75:20:5) |
| Energy | 0.005 | 0.36 | 1.3 |
| (WH/Kg) | | | |
| 1 mA/1 V) | | | |
| Power (W/Kg) | 0.002 | 0.001 | 0.001 |

TABLE 21
Performance of coin cells

| | Pellet | Charged | Discharged | | |
|---|---|---|---|---|---|
| | Disk Wt | Coulombs | Coulombs | Time | Potential |
| Material | (g) | (Q) | (Q) | (s) | Step (V) |
| PAC ™ 1003 | 0.2397 | 1 | 0.54 | 200 | 0 to 1.5 V |
| PAC ™ 1003/ | 0.1608 | 2.1 | 1.14 | 200 | 0 to 1.5 V |
| PTSA/TSAm | | | | | |
| PAC ™ 1003 | 0.2397 | 0.23 | 0.18 | 100 | 0 to 1 V |
| PAC ™ 1003/ | 0.1608 | 1.2 | 1.09 | 100 | 0 to 1 V |
| PTSA/TSAm | | | | | |

As can be seen in Table 21, the electrodes based on PAC™ 1003/PTSA/TSAm performed better than PAC™ 1003 based electrodes. At high voltage, it was observed that both electrodes had higher charge but the discharging reaction was sluggish and for the time, given, only a portion of the charged was transferred back. At 1 V, even though the charge amount was lower, the transfer back was efficient, supporting the previous observation that polyaniline is stable up to a potential of 1V and stability reduces with increasing potential.

### Paste Formulation of PAC™ 1003 and Activated Carbon

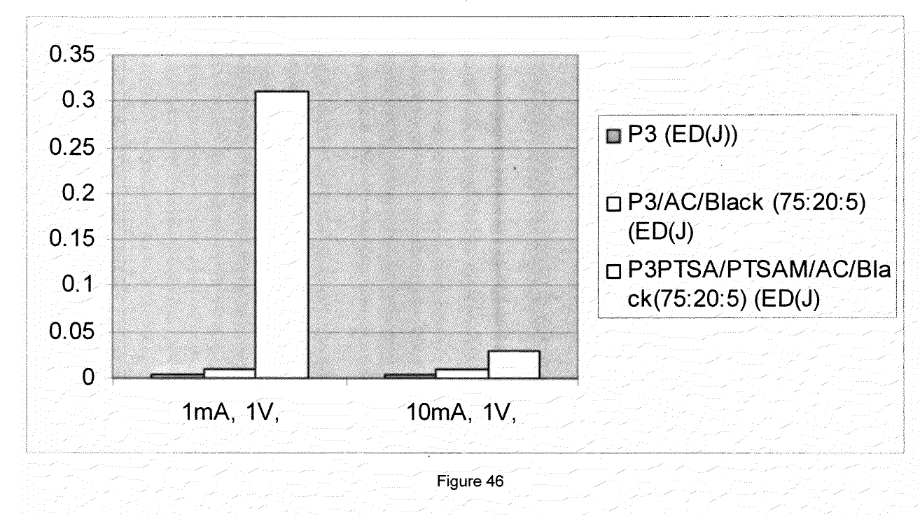

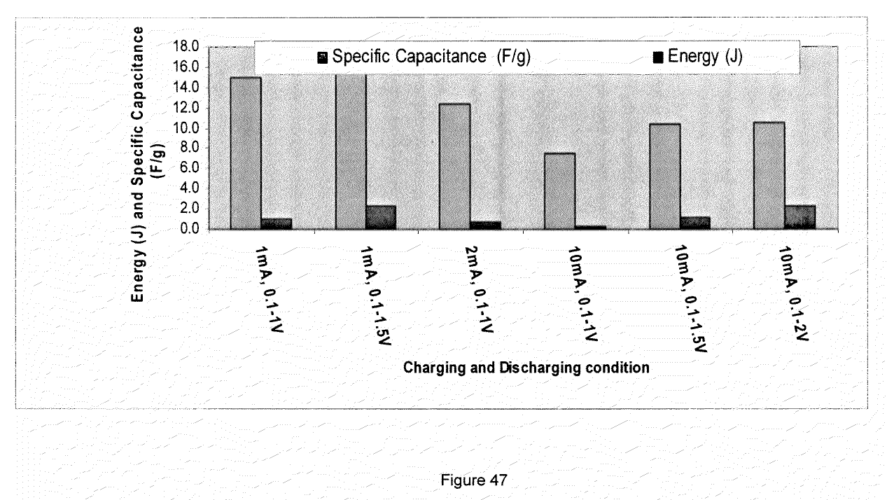

Electrode formulations based on PAC™ 1003/activated carbon pastes demonstrate improvements in both power and energy. Specific capacitance for pellets increased from the 3 F/g to 15 F/g while energy increased from 1.8 Wh/Kg at 10 mA, 1.2V to 4 Wh/kg at the same conditions as seen in FIGS. 46 and 47.

### Example 12

The following is an example of the synthesis of a new dopable ICP. Specifically, this example demonstrates the synthesis of Poly(BEDOT-BBT), a monomer showing promise for use in synthesizing a new dopable ICP.

### Bromination of Benzodithiazole

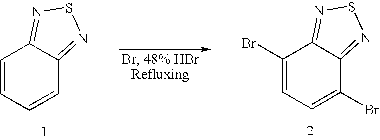

An oven dried 250 mL three-necked round bottom flask was connected to a refluxing condenser, an additional funnel and a glass stopper. A magnetic stirrer bar was placed in flask. The top of the refluxing condenser was connected with gas ventilation into a strong base solution. Then, benzodithiazole 1 (2.8 g, 20.6 mmol) and 50 mL of HBr (40%) were charged to the flask. Bromine (3.3 mL, 64.4 mmol) was placed into the additional funnel and the reaction mixture was refluxed. Then, bromine was added dropwise slowly (over 30 min.) into the refluxing mixture. After complete addition of the bromine, the mixture was refluxed an additional 2 hours and cooled to room temperature. The resulting orange slurry was poured to ice water. The precipitant was collected by filtration and the filtered solid was washed with water and dried under vacuum overnight, affording the crude solid 2 in 95% yield (6.05 g). The product was purified by recrystallization with acetone. The final fine pale-yellow needle type crystal obtained within 84% yield (5.06 g). The compound 2 was confirmed by ¹³C NMR.

¹³C NMR (100 MHz, DMSO) δ 113.78, 133.47, 152.97

2) Nitration of 4,7-dibromobenzodithizol

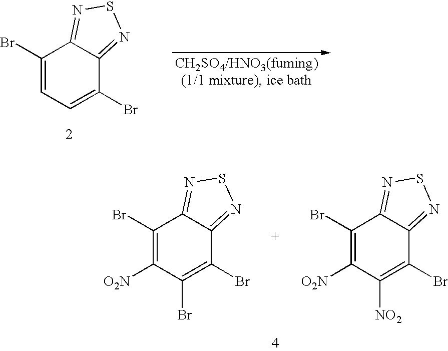

Compound 2 (4.0 g, 13.6 mmol) was slowly added to a mixture of conc. H₂SO₄ and conc. fuming HNO₃ (1/1, 40 mL) at 0-5° C. in an ice bath. The colorless acid mixture turned to orange slurry. After adding compound 2, the ice bath was removed and the reaction was stirred an additional 2 hours at room temperature. The reaction mixture was poured into ice water to give pale-yellow precipitation. The solids were filtered and washed with water. The crude solid yielded 2.5 g after vacuum drying. The product was separated and predicated by column chromatograph using silica gel as elutant with acetone/hexane (1/2). Rf=0.26 (in Acetone/Hexane=½). The product was confirmed by ¹³C NMR in DMSO-d⁶.

¹³C NMR (100 MHz, DMSO) δ 112.05, 144.35, 152.20

### 3) EDOT-SnBu3

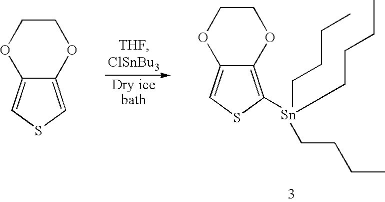

EDOT (6.39 g, 45 mmol) was dissolved in fresh THF (50 mL), and the solution was cooled to −78° C. in dry ice bath. Butyllithium (28.1 mL, 1.6 M in hexane, 45 mmol) was added dropwise and the mixture was stirred at −78° C. for 1 h. Tributyltin chloride (45 mL, 1M in hexane, 45 mmol) was then added dropwise, and the mixture was allowed to warm to RT with stirring overnight. Water (30 mL) was added followed by ether (50 mL). The phases were separated, and the organic layer was dried with MgSO₄, filtered and evaporated to dryness to give the product as a slight brown oil (10.8 g, 79%). Compound 3 was used in the next reaction without purification.

### 4) BEDOT-BT(NO₂)₂

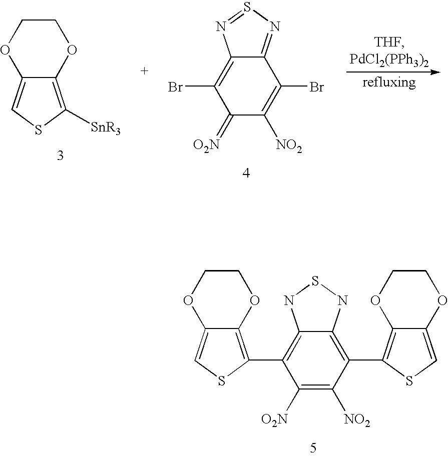

To a flame dried 100 mL 3-neck round bottom flask was added 25 mL of THF then 0.23 g (0.33 mmol) of Pd(II) Cl₂(PPh₃)₂ and 5.83 g (14 mmol) of tributyltinEDOT (Compound 3). The solution was degassed for 30 minutes. Then, 2.59 g (6.7 mmol) of Compound 4 was added and the solution was refluxed for 3 hours under inert atmosphere. The solution was cooled and the solvent was removed under reduced pressure. Column chromatography (CHCl₃, SiO₂) yielded 2.29 g (68%) of a red solid. Rf=0.23 (in CHCl₃).

¹³C NMR (100 MHz, DMSO) δ 64.84, 65.32, 104.70, 106.61, 120.66, 141.40, 142.36, 142.97, 152.78

### 5) BEDOT-BT(NH₂)₂

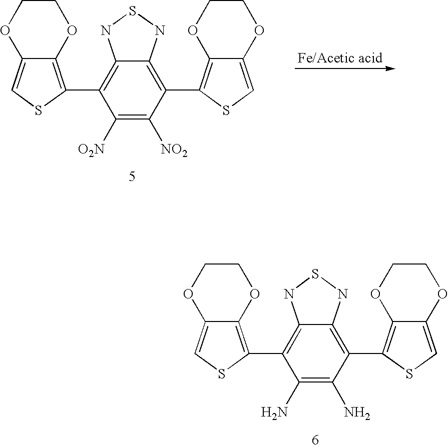

To an oven dried 100 mL 3-neck round bottom flask equipped with a condenser was added 1.04 g (2.0 mmol) of Compound 5 and 1.34 g (2.4 mmol) of iron powder. To this was added 38 mL of degassed AcOH. The reaction was heated to 100° C. for 3 hours and then allowed to cool. A golden yellow color solid was collected by filtration and washed with water, saturated sodium bicarbonate, and water in this order. After drying under vacuum, the reaction yielded 0.72 g (81%) of a greenish yellow solid. The final product was used in the next reaction without purification.

¹H NMR (300 MHz, DMSO) δ 4.22 (s, 8H), 5.70 (s, 4H), 6.73 (s, 2H); ¹³C NMR (100 MHz, DMSO) δ 64.80, 65.32, 99.23, 100.34, 109.85, 139.63, 141.37, 142.17, 151.34.

### 6) BEDOT-BBT

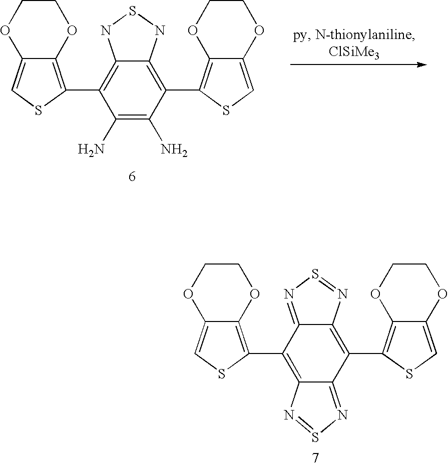

To an oven dried 25 mL 3-neck round bottom flask was added 0.55 g (1.2 mmol) of Compound 6, 6 mL of anhydrous pyridine, 0.23 mL (2.6 mmol) of N-thionylaniline, and 0.28 mL (2.2 mmol) of TMSCl. The solution mixture was heated to 80° C. overnight. The reaction was allowed to cool, poured into water, and a dark purple solid was collected by filtration. Column chromatography (CH₂Cl₂,SiO₂) yielded 0.46 g (84%) of a dark purple solid. Rf=0.15 (in DCM) The compound 7 was not very soluble in DMSO-d⁶ rendering NMR characterization unreliable.

### 7) Poly(BEDOT-BBT)

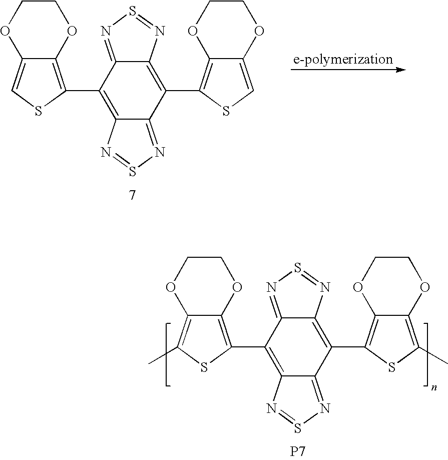

Chronoamperometry (potentiostatic) of the monomer was carried out with a Princeton Applied Research Advanced electrochemical System PARSTAT 2273 in a three compartment H-cell in 5 mM or 1 mM monomer in DCM containing 0.1 M tetrabutylammonium perchlorate (nBu₄NClO₄, TBAP) at the potential 0.8 V. Solutions were degassed by inert gas bubbling before use. A large area stainless steel or Au interfacial layered SS (φ=0.75 inch), Pt gauze, and 10 mM Ag/AgNO₃ in 0.1 M TBAP/ACN were used as the working, counter and reference electrodes, respectively. Redox property characterization of the polymer was performed in monomer free electrolyte in 0.1 M TBAP/ACN or 0.1 M TBAP/PC. The inert gas stream was maintained over the solution

For measurements of UV-Vis-NIR spectra, the polymer was deposited onto an ITO coated glass electrode under the same conditions in CV technique. Dedoping was performed by electrochemical reduction (applying negative potential at −0.4 V for 1 min.).

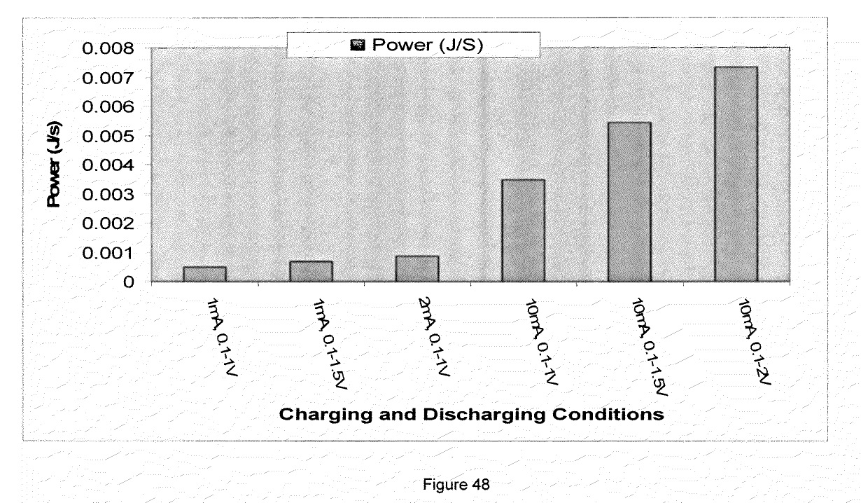

As discussed above, the present polymer was electrochemically polymerized (deposited) from a 5 mM or 1 mM concentration monomer in 0.1 M TBAP/DCM solution onto each of a Pt button, Au button, or ITO coated glass via repeat scan cyclic voltammetry method (FIG. 48). Pt or Au button (φ=0.2 cm), Pt wire, and Ag/AgNO₃ were used as the working, counter and reference electrodes, respectively. CV of the polymer was performed in monomer free electrolyte (0.1 M in TBAP/ACN). The nitrogen gas stream was maintained over the solution during experiment. Polymer was prepared by a cyclic potential sweep technique (−0.4-0.9 V) with 5 mM or 1 mM monomer solution under the same conditions described above. The obtained polymer was a dark-green insoluble film.

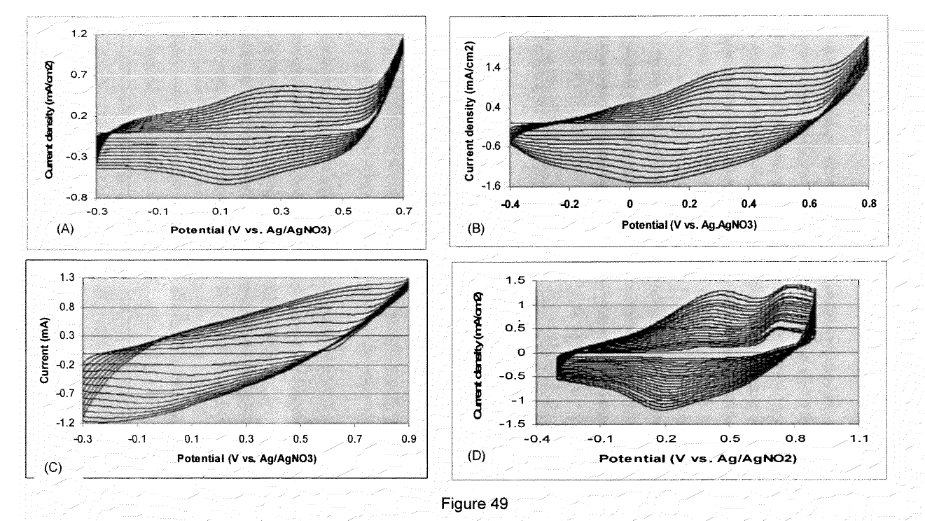

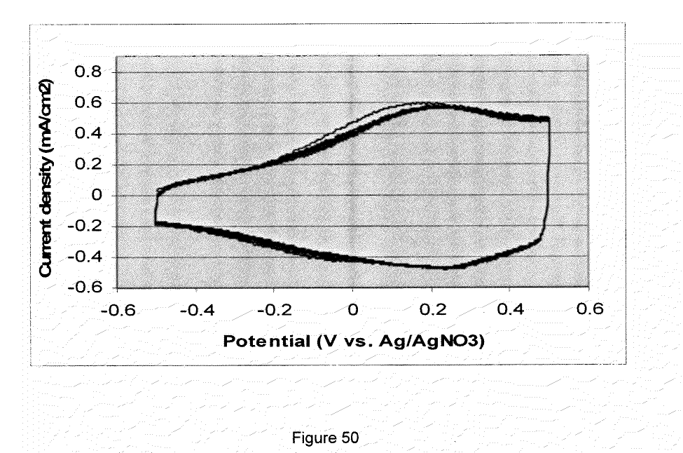

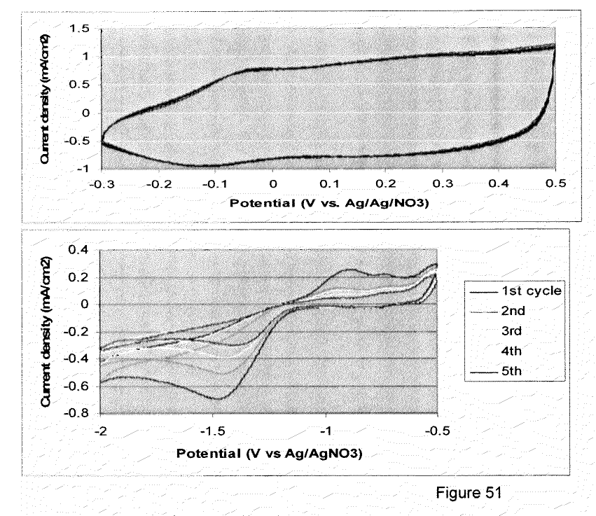

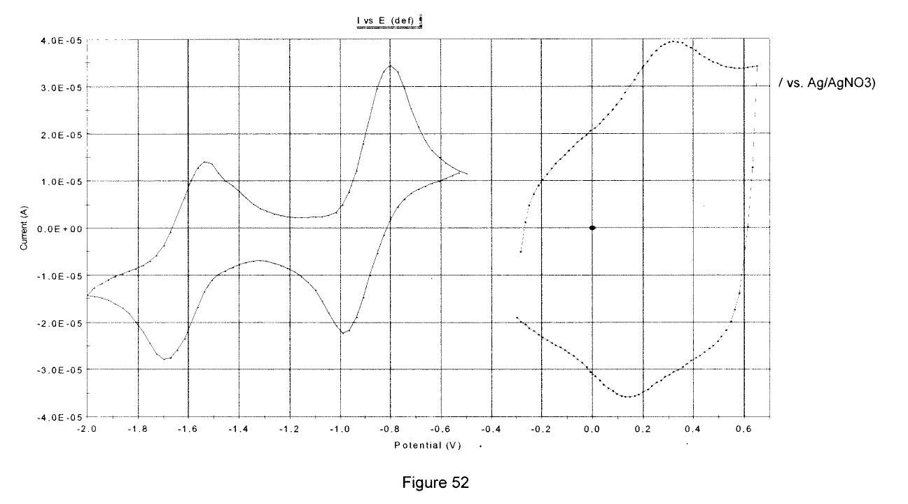

All electrodeposited dark-green polymer films were removed from monomer solution, gently rinsed with and immersed in their respective electrolyte solution (0.1 M TBAP/ACN). To characterize their redox processes and to determine the stability of the polymer films towards repeated electrochemical decomposition upon switching, as shown in FIGS. 49 and 50, the films were subjected to several potentiodynamic scans whose switching potentials were chosen as points outside the electrochemical diffusion tails. CV of polymer shows an E_{1/2} of 0.22 V (V vs. Ag/AgNO₃) for oxidation (p-dopable) at Pt button working electrode but reduction redox process was not clearly showed because the anionic radical degenerated by moisture and oxygen. FIGS. 51 and 52-(A) show no decrease of the redox cyclic peak and illustrate a very stable redox process in this polymer.

Clear p- and n-dopable waves in 0.1M TBAP/PC under bubbling nitrogen were obtained. Cyclic voltammetry of poly(BEDOT-BBT) P7 shows an E1/2 of 0.24 V for oxidation and two reductions with E1/2 at −0.88 and −1.62 V, respectively (FIG. 51). FIG. 52 shows cyclic voltammetry of polymer redox stability. Positive redox cycles (P-type property) were very stable over 90 cycles. However, negative redox cycles (N-type property) were not stable indicating reduction peak intensity decreased 92% after 40 cycles at 50 mV/s scan rate. The second n-dopable state (dianions) was not very stable due to degradation of the polymer's electro-active properties (breaking of the conjugation back bone).

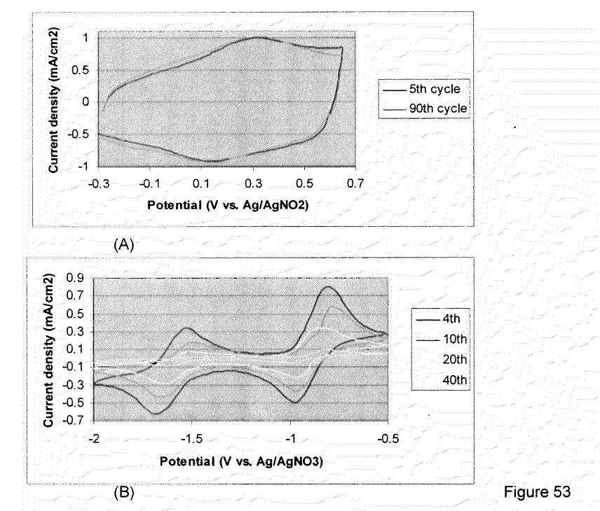

The resulting polymer film on an Au button was subjected to a series of scan rate dependence experiments within the polymer response potential window (FIG. 53-(A)). The polymer showed capacitative behavior to moderate scan rates (50-500 mV/s). Specific area capacitance of the polymer film was determined as a function of scan rate in a three-point electrochemical cell configuration (FIG. 53-(B)). At scan rates below 500 mV/s, P(BEDOT-BBT) film carry higher specific area capacitance.

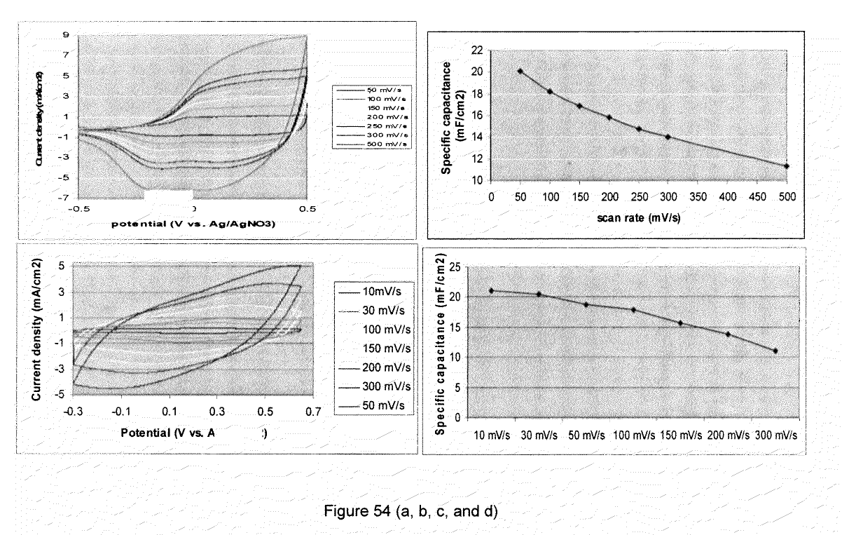

In FIG. 54, UV-Vis spectrum of Monomer, BEDOT-BBT in DCM shows a λₘₐₓ=638 nm (blue). To study polymer optical properties, monomer solutions of 5 mM concentration were prepared in a dichloromethane (DCM)-supporting electrolyte media (0.1 M TBAP/DCM). The solutions were then subjected to repeated scanning electropolymerization onto an ITO-coated glass working electrode (FIG. 53-(C)). After depositing the polymer, dark-green polymer films were removed from monomer solution, gently rinsed with acetonitrile (ACN) and dried. A spectrum was obtained under solvent-free condition.

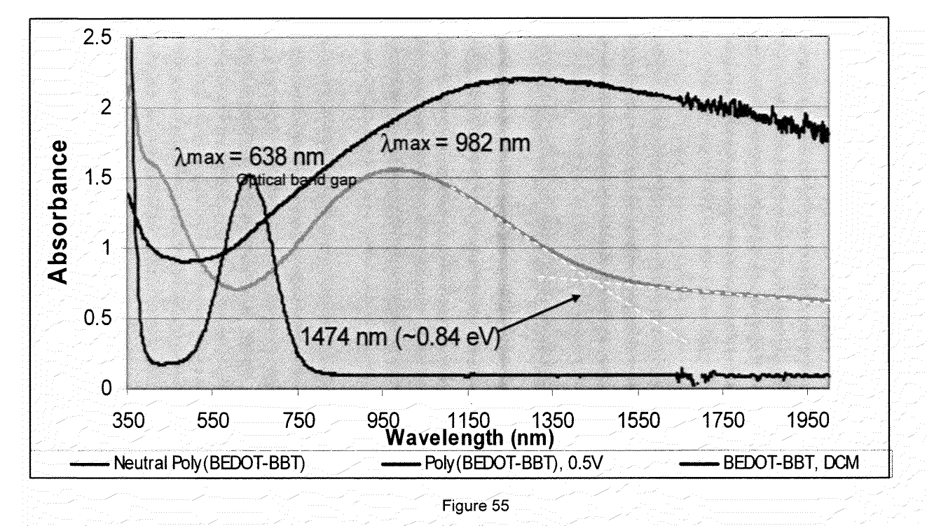

In FIG. 55, UV-Vis-NIR spectrum of poly(BEDOT-BBT) shows λₘₐₓ=982 nm (green) for neutral state, which was obtained from applying negative potential (−0.4 V) for 2 min in 0.1 M TBAP/ACN. This gives an optical band gap of 0.84 eV (1 eV=1240 nm). P-doped UV-vis-NIR spectrum also was obtained from applying positive potential (0.5 V) for 2 min in 0.1 M TBAP/ACN. On the p-doping (oxidation) state, the UV-Vis-NIR spectrum showed the π-π*transition intensity decreased while the NIR region intensity increased.

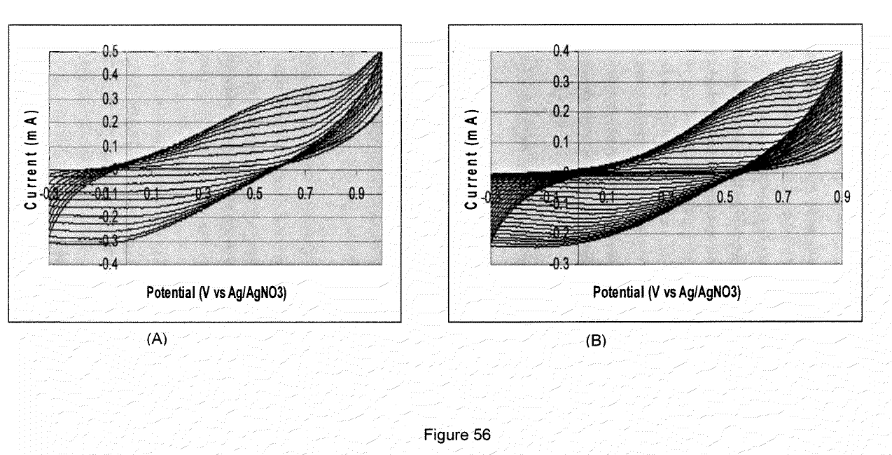

Following this, the polymer was electrochemically deposited from a 5 mM concentration monomer, 0.1 M TBAP/DCM solution onto each of stainless steel disks (φ=0.75 inch), stainless steel with Au interfacial layer, via potential sweep scan cyclic voltammetry method (FIG. 56). Cyclic voltammetry (CV) of monomer was carried out with a Princeton Applied Research Advanced Electrochemical System PARSTAT 2273 in a three compartment cell at a scan rate of 50 mV/s. Solutions were degassed by nitrogen bubbling before use.

Although cyclic voltammetry offers a powerful method for the characterization of the monomer and polymer redox processes, it lacks the ability to precisely control polymer film thickness. The reason for this lack of fine control with CV is that only part of the total energy input into the system is output into a surface-adsorbed electropolymerized film. However, there is the complexity of the reaction pathway that may commence upon energy input into the system. It can be seen that a number of Faradaic and non-Faradaic processes occur in the electrochemical cell, including capacitive charging, reaction with contaminants, and termination of oxidized monomer.

In essence, the cyclic voltammetric system, while consisting of essentially several repeated polymerizations under the same conditions as the previous electropolymerization, the actual process of adding new polymer to the electrode surface and into the solution, as well as the expansion of the diffusion layer generates completely different reaction conditions (sometimes accompanied by a shift in the redox potential of the monomer, and even further complicates the kinetics). Therefore, it can not be assumed that the same amount of polymer is deposited onto the electrode surface with each repeated scan.

Potentiostatic deposition provides a convenient solution to this problem. Because the voltage is held constant in the potentiostatic deposition, the dynamic elements such as scan rate and the potential ramp that were present in the CV are eliminated. Additionally, assuming fast non-Faradaic charging kinetics, capacitive current should reach values close to zero after a short period of time. Therefore, at extended potentiostatic deposition times, the Faradaic processes will dominate the measured currents. Conveniently, the film thickness and polymer amount can be carefully controlled by terminating the potentiostatic deposition after a certain charge density has been achieved. The potentiostatic deposition can be controlled their film thickness (polymer amount) in that the film thickness (polymer amount) versus charge density applied to the system (assuming the electrochemical systems are reproduced with the exact same concentrations and compositions) obeys a linear trend up to about 3 μM for the polymerization of pyrrole, poly(3,4-alkylenedioxypyrrole)s. The data points in these curves represent individual experiments, so they can be constructed as a calibration curve for controlling the film thickness and polymer amount.

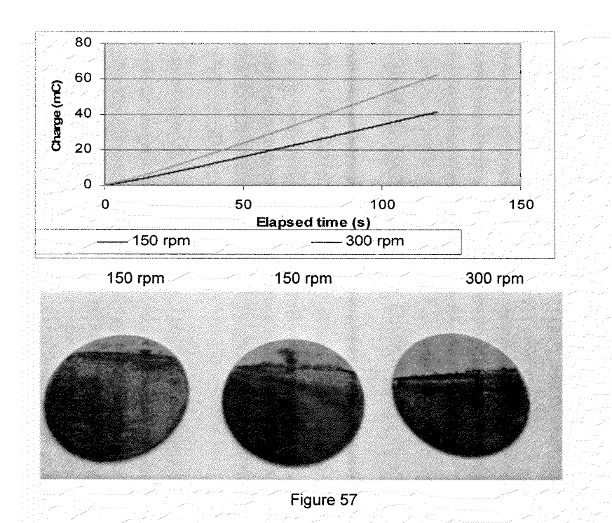

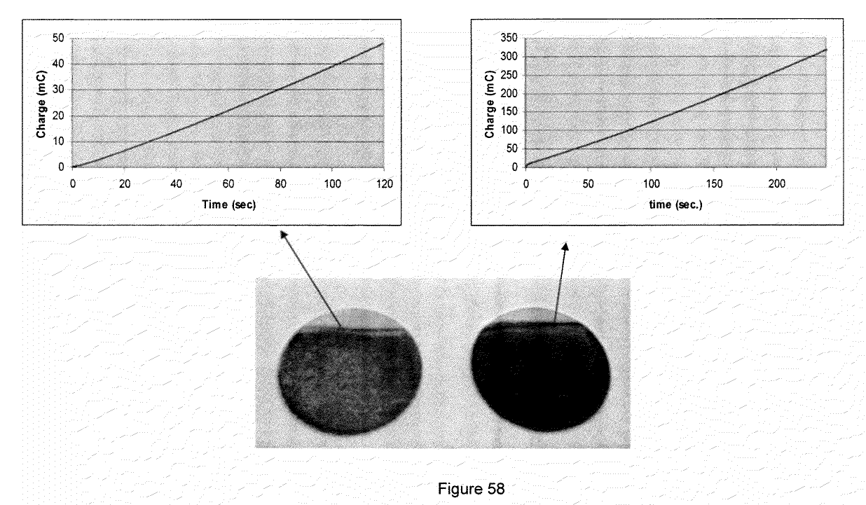

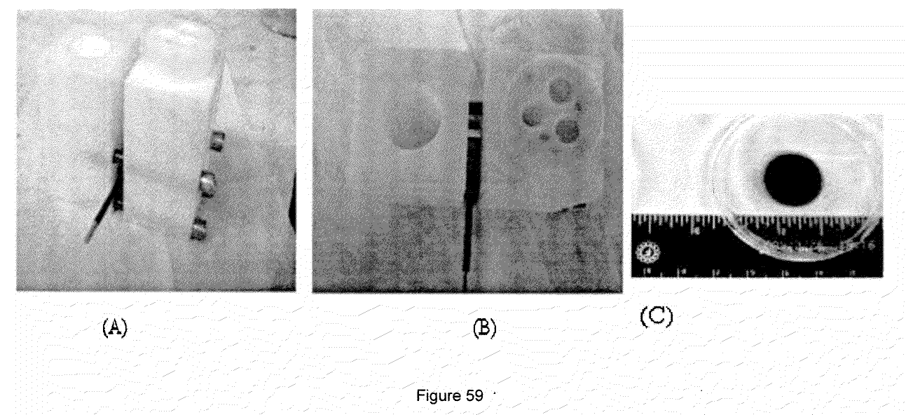

To overcome the problems posed by the CV deposition technique, a chronoamperometry method (potentiostatic method) was used for BEDOT-BBT polymer deposition. Poly(BEDOT-BBT) film was obtained on gold-coated stainless steel as well as uncoated stainless steel disks using the chronoamperometry method. The applied potential was 0.7 V (vs. Ag/AgNO₃) for different time periods and the monomer solution was stirred to maintain solution homogeneity during the polymer deposition. The deposited film appeared very stable on the SS surface without any sign of de-lamination. FIG. 57 shows the chronoamperometry results of the polymer deposition using 5 mM monomer solution deposited onto a gold-coated SS substrate at different solution stirring speeds. A linear trend was observed in the charge vs. deposition time plot i.e., the longer the deposition time, the higher the amount of polymer mass deposited. Additionally, the higher the stir speed, the higher the amount of polymer deposited onto substrate (see FIG. 58). During the polymerization step, the n-dopable polymer deposits on both sides of the high conducting substrates and in addition, the coated polymer lacks homogeneity (i.e., poor uniformity in coverage). To solve these problems, an H-cell was designed (see FIG. 59) that facilitates the polymer coating on only one side of the disk with good quality and controllable uniformity and thickness as well.

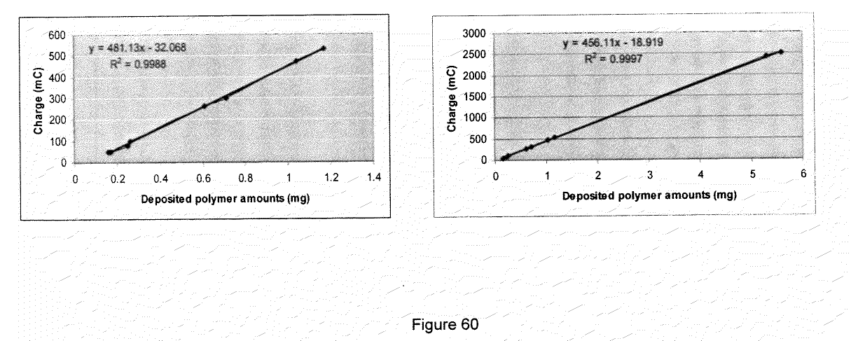

The monomer BEDOT-BBT in 0.1 M TBAP/DCM was electro-deposited (polymerized) on stainless steel working electrode with three electrode H-cell using a chronoamperometry method (potentiostatic) at 0.7 V or 0.8 V. The deposit condition and results are shown in Table 22. The resulting polymer deposit amount to charge plot displayed good linear relation (see FIG. 60) until 5 mg deposition. In addition, polymer amount obtained by charge controlled (50 mC or 100 mC) experiment placed onto closed linear line. The potentiostatic method was a good method to control polymer amounts or film thickness.

TABLE 22
Elctro-deposition of poly(BEDOT-BBT) by chronoamperometry
method

| ^{a}Monomer | | | Applied P | | ^{d}Polymer | | | |
|---|---|---|---|---|---|---|---|---|
| solution | | | (V vs | Time | amount | Charge | ^{e}Thickness | ^{f}Control |
| conc. | Sample | ^{c}RPM | Ag/AgNO₃) | (sec.) | (mg) | (mC) | (micron) | exp. |
| 1 mM | ^{b}JJH3046 SS(Au) | 300 | 0.8 | 163 | 0.16 | 50 | | yes |
| | JJH3046 SS | 300 | 0.8 | 51 | 0.17 | 50 | | yes |
| 5 mM | JJH3033_D2_SS1 | 300 | 0.7 | 240 | 0.25 | 78 | 1.71 | |
| | JJH3038_D3_SS | 600 | 0.8 | 500 | 0.71 | 299 | | |
| | JJH3038_D4_SS | 0 | 0.8 | 500 | 0.61 | 265 | | |
| | JJH3036_D1_SS | 600 | 0.8 | 1000 | 1.04 | 472 | | |
| | JJH3036_D2_SS | 600 | 0.8 | 1000 | 1.17 | 532 | | |
| | JJH3035_D1_SS | 600 | 0.8 | 5000 | 5.3 | 2423 | | |
| | JJH3035_D2_SS | 600 | 0.8 | 5000 | 5.59 | 2502 | | |
| | JJH3040_D5_SS | 300 | 0.8 | 154 | 0.26 | 100 | | yes |

All polymer depositions used three electrodes H-cell. Stainless steel (Φ = 0.75 inch) was used as the working electrode; Pt gauze and 10 mM Ag/AgNO₃ in 0.1 M TBAP/CAN was used for counter and reference electrodes. All polymers were deposited by electronically applied negative potential.
^{a}Monomer concentration in 0.1 M TBAP/dichloromethane (DOM).
^{b}Gold thermal deposition on the stainless steel substrate for better device performance, the thickness of gold interfacial layer is approximately 10 nm.
^{c}monomer solution stirring speed.
^{d}polymer amounts were measured by which subtracted to initial weigh from total weight after polymer deposition using microbalance.
^{e}thickness was measured by con-focal electromicroscope.
^{f}polymer deposition was controlled by passing charge amount.

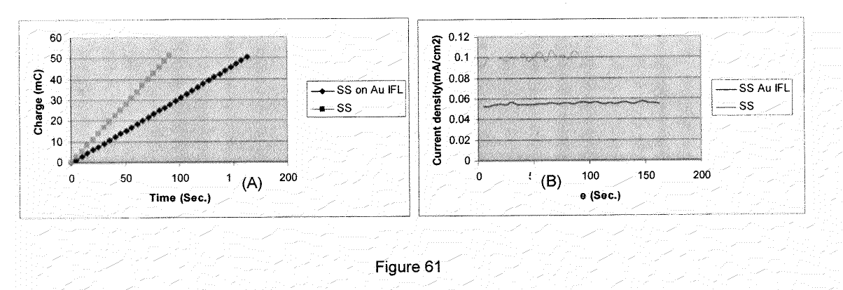

In FIG. 61, the Chronoamperometry diagram shows polymer was deposited on gold IFL SS and SS substrate under control conditions. Both polymer amounts were measured as quite similar as a 0.16 mg and 0.17 mg for SS(Au) and SS under the same conditions. However, deposit time and current flow during the deposition were different. SS substrate showed faster deposition than SS(Au). The current flow of SS(Au) displayed lower than the current flow of SS during the deposition. Also, SS(Au) substrate gave better current flow stability during the deposition. It was expected that the gold IFL (high conducting layer) SS would result in lower current flow electrically so polymer would deposit faster than without gold layer. But, the chronoamperometry diagram showed unexpected results. Without being bound by theory, it is believed there is relationship between surface roughness and area. High surface area should be faster deposition. The SS without Au IFL may be sufficiently rough (high surface area) that polymer deposited faster than SS(Au IFL).

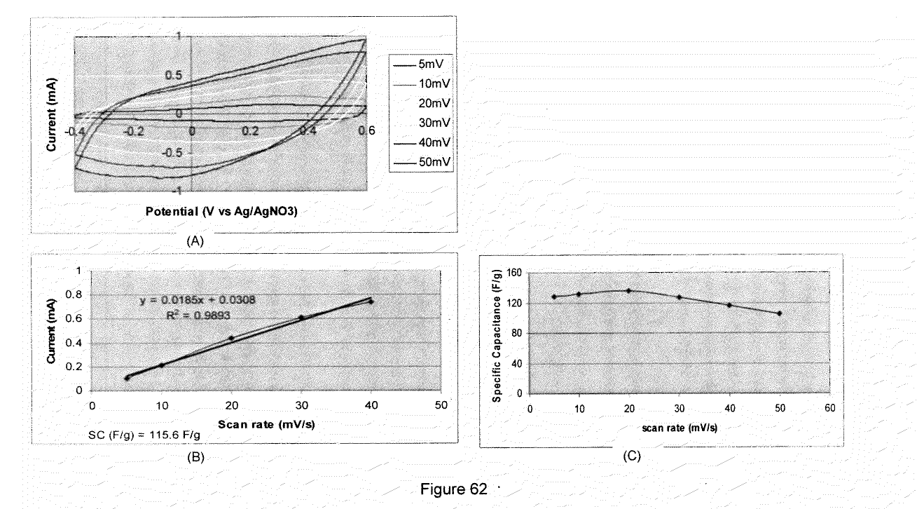

The resulting polymer film of 0.16 mg at Au IFL SS (φ=0.75 inch) was subjected to a series of scan rate dependence experiments within the polymer response positive potential window (FIG. 62-(A)). The polymer showed capacitative behavior to moderate scan rates (5-50 mV/s). Specific capacitance (F/g) of the polymer film was determined as a function of scan rate in a three-point electrochemical cell configuration (FIG. 62-(B)). The specific capacitance of p-type was 116 F/g.

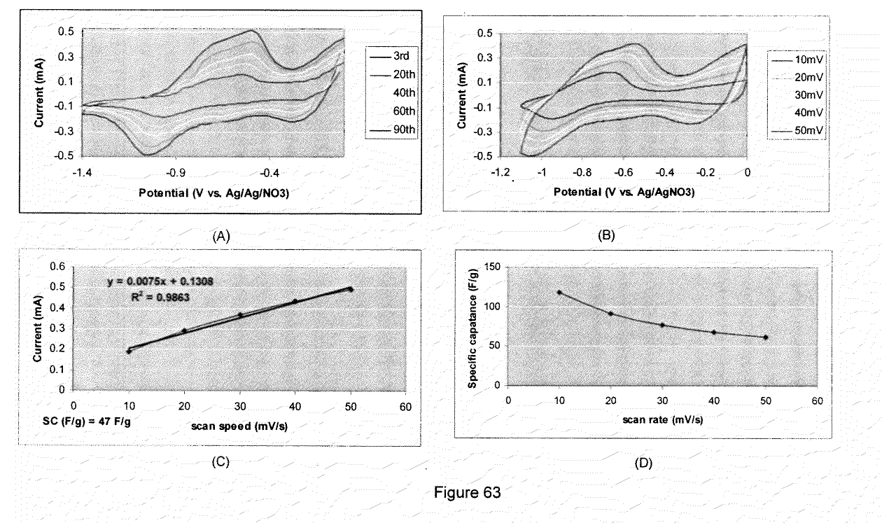

As previously discussed with respect to n-dopable redox stability, fully n-dopable redox cycles (N-type property) were not very stable; the first reduction peak intensity decreased 92% after 40 cycles at 50 mV/s scan rate. The n-dopable redox stability was tested in a small potential window between −1.4 and 0 V under argon for 90 cycles (see FIG. 63-(A)). The first n-dopable redox wave was stable. The current intensity decreased 63% after 90 cycles.

Additionally, the resulting polymer film of 0.16 mg at Au IFL SS (φ=0.75 inch) was subjected to a series of scan rate dependence experiments within the polymer response negative potential window (FIG. 63-(B)). The polymer showed capacitative behavior to moderate scan rates (10-50 mV/s). Specific capacitance (F/g) of the polymer film was determined as a function of scan rate in a three-point electrochemical cell configuration (FIG. 63-(C)). The specific capacitance of n-dopable polymer is 47 F/g in a three electrode cell. Specific capacitance (F/g) of the polymer film was determined as a function of scan rate in a three-point electrochemical cell configuration (FIG. 63-(D)). At scan rates below 50 mV/s, P(BEDOT-BBT) film carried higher specific capacitance (F/g).

The synthesis and spectroscopic characterization of BEDOT-BBT as a precursor of n-dopable polymer discussed in the present example demonstrated:
1. All reaction steps and yields were repeatable.
2. BEDOT-BBT was electro-polymerized (deposited) well to give Poly(BEDOT-BBT) film on ITO, 0.2 cm Pt or Au working electrode as well as 0.75 inch (1.9 cm) gold interfacial stainless steel (SS/Au) or just stainless steel (SS) substrate.
3. Optical band-gap of Poly(BEDOT-BBT) obtained by UV-vis-NIR spectrum was 0.84 eV.
4. Newly designed three electrodes H-cell configuration systems gave good quality Poly(BEDOT-BBT) film on SS or SS (Au IFL) substrates.
5. Chronoamperometry method for polymer deposit gave better control for deposited polymer amounts
6. Polymer deposition onto SS was faster than SS (Au IFL). However, SS (Au IFL) showed a more stable electric current flow during polymer deposition.
7. Specific capacitance of the novel n-dopable polymer was 47 F/g in a three electrode H-cell.

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions without departing from the scope of the invention, it is intended that all matter contained in the above description and shown in the accompanying drawings shall be interpreted as illustrative and not in a limiting sense.

What is claimed is:

1. A supercapacitor comprising:
a first substrate comprising a first and second surface;
a first electrode comprising an intrinsically conductive polymer having a conductivity of at least about 800 S/cm and having a first and second side, wherein the first side is adjacent the second surface of the first substrate;
an electrolyte adjacent the second side of the first electrode;
a second electrode comprising an intrinsically conductive polymer having a conductivity of at least about 800 S/cm and having a first side and a second side, wherein the first side is adjacent the second side of the first electrode and separated from the first electrode by the electrolyte; and
a second substrate having a first surface and a second surface, wherein the first surface is adjacent the second side of the second electrode.

2. The supercapacitor according to claim 1, wherein the first and second substrate comprise different material than one another.

3. The supercapacitor according to claim 1, wherein the first and second substrate comprise the same material as one another.

4. The supercapacitor according to claim 1, wherein the first intrinsically conductive polymer and the second intrinsically conductive polymer comprise the same intrinsically conductive polymers as one another.

5. The supercapacitor according to claim 1, wherein the first intrinsically conductive polymer and the second intrinsically conductive polymer comprise different intrinsically conductive polymers.

6. The supercapacitor according to claim 1, wherein the first and second intrinsically conductive polymers are selected from one or more of polyaniline, polypyrrole, polyacetylene, polythiophene, poly(phenylene vinylene), polyethylenedioxythiophene, and poly(bisetheylenedioxythiophene-bisbenzothiadiazole).

7. The supercapacitor according to claim 1, wherein the each of the first and second intrinsically conductive polymers are doped.

8. The supercapacitor according to claim 1, wherein each of the first and second intrinsically conductive polymers are acid doped.

9. The supercapacitor according to claim 8, wherein the polymers are doped with an acid selected from one or more of is selected from one or more of 4-sulfophthalic acid, p-toluenesulfonic acid, benzenesulfonic acid, phenylphosphonic acid, phosphoric acid, camphorsulfonic acid, p-toluenesulfonamide and compounds having the formula: 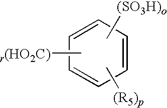
wherein: o is 1, 2 or 3; r and p are the same or are different and are 0, 1 or 2; and R₅ is alkyl, fluoro, or alkyl substituted with one or more fluoro or cyano groups.

10. The supercapacitor according to claim 1, further comprising at least one interfacial layer adjacent one of the first or second electrodes.

11. The supercapacitor according to claim 10, wherein the at least one interfacial layer is selected from one or more of gold, platinum, chromium, titanium, and iridium.

12. The supercapacitor according to claim 1, further comprising at least one spacer between the first substrate and the first electrode.

13. The supercapacitor according to claim 1, further comprising at least one spacer between the second substrate and the second electrode.

14. The supercapacitor according to claim 1, wherein the supercapacitor is a coin cell supercapacitor.

15. A method of doping an intrinsically conductive polymer film, the method comprising:
contacting the film with a first acid dopant to form a primary doped intrinsically conductive polymer film;
cleaning the primary doped intrinsically conductive polymer film by contacting the primary doped intrinsically conductive polymer film with a vapor;
dipping the vapor-cleaned primary doped intrinsically conductive polymer film into a solution including a second acid dopant and an organic solvent to form a secondary doped intrinsically conductive polymer film; and
annealing the secondary doped intrinsically conductive polymer film to produce a tertiary doped intrinsically conductive polymer film.

16. The method according to claim 15, wherein the first acid dopant comprises more than one acid.

17. The method according to claim 15, wherein the second acid dopant comprises more than one acid.

18. The method according to claim 15, wherein the first and second acid dopant are different protonic acids.

19. The method according to claim 15, wherein the first and second acid dopant are the same protonic acids.

20. The method according to claim 15, wherein the first and second acid dopants are selected from one or more of 4-sulfophthalic acid, p-toluenesulfonic acid, benzenesulfonic acid, phenylphosphonic acid, phosphoric acid, camphorsulfonic acid, p-toluenesulfonamide and compounds having the formula: 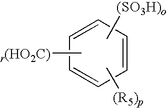
wherein: o is 1, 2 or 3; r and p are the same or are different and are 0, 1 or 2; and R₅ is alkyl, fluoro, or alkyl substituted with one or more fluoro or cyano groups.

21. The method according to claim 15, wherein the intrinsically conductive polymer film comprises one or more of polyaniline, polypyrrole, polyacetylene, polythiophene, poly(phenylene vinylene), polyethylenedioxythiophene, and poly(bisetheylenedioxythiophene-bisbenzothiadiazole).

22. The method according to claim 15, wherein the vapor is selected from one or more of thymol, carvacrol, isopropyl phenol, diisopropyl phenol, isopropanol, diisopropanol, and meta-cresol.

23. The method according to claim 15, wherein the organic solvent is selected from one or both of n-butanol and butylcellosolve.

24. The method according to claim 15, wherein the annealing step is a mechanical annealing step.

25. The method according to claim 15, wherein the annealing step is a chemical annealing step.

26. The method according to claim 15, wherein the annealing step comprises mechanical annealing and chemical annealing.

27. A doped intrinsically conductive polymer film, wherein the film has a conductivity of at least about 800 S/cm.

28. The film according to claim 26, wherein the film has a conductivity of at least about 1000 S/cm.

29. A method of cleaning a primary-doped intrinsically conductive polymer film, the method comprising contacting the film with a vapor selected from one or more of thymol, carvacrol, isopropyl phenol, diisopropyl phenol, isopropanol, diisopropanol, and meta-cresol.

30. A method of secondary and tertiary doping a primary doped intrinsically conductive polymer film, the method comprising:
dipping the primary doped intrinsically conductive polymer film into a solution including at least a second acid dopant and an organic solvent to form a secondary doped intrinsically conductive polymer film;
annealing the secondary doped intrinsically conductive polymer film to produce a tertiary doped intrinsically conductive polymer film.

31. The method according to claim 30, wherein the annealing step comprises mechanical annealing.

32. The method according to claim 30, wherein the annealing step comprises chemical annealing.

33. The method according to claim 30, wherein the annealing step comprises mechanical annealing and chemical annealing.
